(19) United States
(12) Patent Application Publication
(10) Pub. No.: US 2007/0222564 A1
(43) Pub. Date: Sep. 27, 2007

(54) Vehicle Wheel Stealing Detecting Apparatus, Vehicle Wheel Stealing Detecting Method, Vehicle Wheel Stealing Detecting Program, and Recording Medium Storage Vehicle Wheel Stealing Detecting Program

(75) Inventor: Hideyuki Kobayashi, Kyoto (JP)

Correspondence Address: FOLEY AND LARDNER LLP;SUITE 500, 3000 K STREET NW, WASHINGTON, DC, 20007, US

(73) Assignee: OMRON CORPORATION

(21) Appl. No.: 11/587,399

(22) PCT Filed: Aug. 10, 2005
(86) PCT No.: PCT/JP05/14671

§ 371 Date: Oct. 24, 2006

(30) Foreign Application Priority Data
Sep. 7, 2004 (JP) 2004-260252

(51) Int. Cl. B60R 25/10

(52) U.S. Cl. 340/429

(57) ABSTRACT

A vehicle wheel stealing detecting apparatus (1) includes: a vibration sensor (2) for measuring a vibration of the vehicle; a frequency converting section (16) for converting (i) a result of the measurement carried out by the vibration sensor (2), into (ii) frequency domain data; feature amount extracting section (17) for extracting, from the frequency domain data, a plurality of feature amounts respectively corresponding to frequency bands; and recognition processing section (18) for distinguishing, in accordance with the feature amounts, between (i) a vibration occurring in the vehicle due to force exerted to turn fixing means that fixes the vehicle wheel to the vehicle, and (ii) a vibration due to another factor.

### TECHNICAL FIELD

The present invention relates to a vehicle wheel stealing detecting apparatus, a vehicle wheel stealing detecting method, a vehicle wheel stealing detecting program, and a recording medium storing the vehicle wheel stealing detecting program, whereby an action of removing a vehicle wheel from a vehicle is detected.

### BACKGROUND ART

In recent years, a vehicle wheel or a member constituting the vehicle wheel have been frequently stolen. Examples of the member constituting the vehicle wheel include a tire, a wheel, and the like. Developed in light of this are various types of stealing detecting apparatus for detecting such stealing.

Such conventional stealing detecting apparatuses are described in, e.g., (i) Publicly known document 1 (KATO-DENKI Inc., “507T Tilt/motion sensor” [online] Accessed on Aug. 30, 2004, Internet <URL: http://www.kato-denki.com/option/sensor/507t.html>; (ii) Publicly known document 2 [KATO-DENKI Inc., “633M digital tilt sensor” Internet <URL: http://www.kato-denki.com/option/sensor/633m.html>]; (iii) Publicly known document 3 [Kabushiki-gaisha SEPTCH, “BJ-400 series OPTION TS-345 Tire wheel stealing detecting sensor” [online] Accessed on Aug. 30, 2004] Internet <URL: http://www.septch.co.jp/device/01/bj-4.html>; and (iv) Patent document 1 (Japanese Registered Utility Model Publication 3084244; published on Mar. 8, 2002). Specifically, each of Publicly known documents 1 and 2 describes an apparatus using a tilt sensor or the like so as to detect an action of jacking up a vehicle. Publicly known document 3 describes an apparatus using a photoelectric sensor so as to directly detect presence or absence of a tire. Patent document 1 describes an apparatus using a vibration sensor so as to detect unusual vibration caused by the stealing action.

However, the technique using the tilt sensor possibly cannot deal with, e.g., a case where a change of the tilt of the vehicle is slight. Specifically, instead of jacking up the vehicle, blocks, bricks, or the like are placed in a space between the bottom of the vehicle's body and the ground, and then air is released from the tire. This reduces force exerted on the tire against the ground, and then the tire is removed from the vehicle. Further, the technique using the tilt sensor also possibly cannot deal with, e.g., a case of removing the wheel after simultaneously jacking up four portions, adjacent to the respective tires, of the vehicle such that the vehicle is never tilted.

In the meanwhile, in the technique using the photoelectric sensor, sensors need to be so provided as to correspond to the number of the tires. For example, four sensors are required in a vehicle having four vehicle wheels. Further, each of the sensors needs to be fixed in a tire house, so that installation and wiring thereof is difficult. Moreover, the sensor needs to have durability enough to operate in such a very severe environment as the vicinity of the tire. This renders the sensor expensive.

In the meanwhile, in the technique using the vibration sensor, vibration caused by a factor other than the stealing action such as big wind is wrongly recognized as the vibration caused by the stealing action. Consider the case of the technique of Patent document 1, for example. In this case, the vibration is classified into a “strong impact level” or a “weak impact level” in accordance with the level of a signal detected by the detection sensor, and a warning is given according to each of the levels. However, the vibration caused by the factor other than the stealing action, and the vibration caused by the stealing action cannot be surely distinguished from each other only by classifying the vibration into the “strong impact level” or the “weak impact level”.

The present invention was made in light of the problems, and its object is to provide a vehicle wheel stealing detecting apparatus, a vehicle wheel stealing detecting method, a vehicle wheel stealing detecting program, and a recording medium storing the program, whereby an action of removing a vehicle wheel from a vehicle can be detected with high precision.

### DISCLOSURE OF INVENTION

A vehicle wheel stealing detecting apparatus of the present invention, which is provided in a vehicle so as to detect an action of removing a vehicle wheel from the vehicle, includes: vibration measuring means for measuring a vibration of the vehicle; frequency converting means for converting (i) a result of the measurement carried out by the vibration measuring means, into (ii) frequency domain data; feature amount extracting means for extracting, from the frequency domain data, a plurality of feature amounts respectively corresponding to frequency bands; and recognition processing means for distinguishing, in accordance with the feature amounts, between (i) a vibration occurring in the vehicle due to force exerted to turn fixing means that fixes the vehicle wheel to the vehicle, and (ii) a vibration due to another factor.

Here, the vibration measuring means may be, e.g., (i) means for directly measuring a value of the vibration occurring in the vehicle, (ii) means for measuring a velocity of acceleration due to the vibration of the vehicle, or (iii) means for detecting a sound generated inside or outside the vehicle due to turning of the fixing means. Further, the wording “action of removing the vehicle wheel” encompasses (i) an action of removing all the members (e.g., a tire, a wheel, and the like) constituting the vehicle wheel, (ii) an action of removing a part of the members constituting the vehicle wheel. Further, the wording “vehicle” encompasses any vehicle having a vehicle wheel, such as (i) an automobile having four vehicle wheels, (ii) an automobile having vehicle wheels more than four, (iii) an automatic vehicle having two vehicle wheels, (iv) a bicycle, (v) a monocycle, (vi) a tricycle, and the like.

According to the above structure, the frequency converting means converts (i) the result of the measurement carried out by the vibration measuring means, into (ii) the frequency domain data, and the feature amount extracting means extracts, from the frequency domain data, the feature amounts respectively corresponding to the frequency bands, and the recognition processing means distinguishes, in accordance with the feature amounts, between (i) the vibration occurring in the vehicle due to the force exerted to turn the fixing means that fixes the vehicle wheel to the vehicle, and (ii) the vibration due to the other factor. This makes it possible to distinguish (i) the vibration occurring in the vehicle due to the force exerted to turn the fixing means, from (ii) the vibration occurring due to the other factor. Accordingly, the action of removing the vehicle wheel from the vehicle can be detected with high precision.

A vehicle wheel stealing detecting method of the present invention for detecting an action of removing a vehicle wheel from a vehicle, the method includes the steps of: (A) causing vibration measuring means to measure a vibration of the vehicle; (B) converting (i) a result of the measurement carried out by the vibration measuring means, into (ii) frequency domain data; (C) extracting, from the frequency domain data, a plurality of feature amounts respectively corresponding to frequency bands; and (D) distinguishing, in accordance with the feature amounts, between (i) a vibration occurring in the vehicle due to force exerted to turn fixing means that fixes the vehicle wheel to the vehicle, and (ii) a vibration due to another factor.

According to the above method, the result of the measurement carried out by the vibration measuring means is converted into the frequency domain data; and the feature amounts respectively corresponding to the frequency bands are extracted from the frequency domain data; and the vibration occurring in the vehicle due to the force exerted to turn the fixing means that fixes the vehicle wheel to the vehicle, and the vibration due to the other factor are distinguished from each other in accordance with the feature amounts. This makes it possible to distinguish (i) the vibration occurring in the vehicle due to the force exerted to turn the fixing means, from (ii) the vibration occurring due to the other factor. Accordingly, the action of removing the vehicle wheel from the vehicle can be detected with high precision.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 is a block diagram schematically illustrating a structure of a vehicle wheel stealing detecting apparatus according to one embodiment of the present invention.

FIG. 2 is a perspective view illustrating one example of a position in which the vehicle wheel stealing detecting apparatus according to the embodiment of the present invention is installed.

FIG. 3 is an explanatory diagram illustrating a principle how a force for unfixing a nut that fixes a wheel is transferred to a vehicle.

FIG. 4 is an explanatory diagram schematically illustrating a relation between the position of each nut and force for turning the nut.

FIG. 5 is a plan view illustrating a relation between the position of each tire and vibration occurring in the vehicle.

Each of FIGS. 6 is a graph illustrating a result of measuring the vehicle body vibration with the use of a vibration sensor. FIG. 6(a) illustrates a vibration waveform of vehicle body vibration occurring due to turning of a nut. FIG. 6(b) illustrates a vibration waveform of vehicle body vibration occurring due to turning of a nut different from the nut of FIG. 6(a). FIG. 6(c) illustrates a vibration waveform of vehicle body vibration occurring when closing a door of the vehicle. FIG. 6(d) illustrates a vibration waveform of vehicle body vibration occurring during traveling. FIG. 6(e) illustrates a vibration waveform of vehicle body vibration occurring due to big wind while the vehicle is parked.

FIG. 7 is a flowchart illustrating a flow of data processing in the vehicle wheel stealing detecting apparatus of the embodiment of the present invention.

FIG. 8 is a graph illustrating one example of an analog signal that is acquired by a control section of the vehicle wheel stealing detecting apparatus of the embodiment of the present invention, and that indicates the vibration.

FIG. 9 is a graph illustrating another example of the analog signal that is acquired by the control section of the vehicle wheel stealing detecting apparatus of the embodiment of the present invention, and that indicates the vibration.

FIG. 10 is an explanatory diagram illustrating a relation between (i) the direction of the vehicle in which the vehicle wheel stealing detecting apparatus according to the embodiment of the present invention and (ii) the direction in which the vibration sensor carries out the measurement.

FIG. 11 is a block diagram schematically illustrating a structure of a vehicle wheel stealing detecting apparatus according to another embodiment of the present invention.

FIG. 12 is a flowchart illustrating a flow of data processing in the vehicle wheel stealing detecting apparatus of the embodiment of the present invention.

### BEST MODE FOR CARRYING OUT THE INVENTION

The following description deals with further details of the present invention with reference to Embodiments and Comparative Examples; however, the present invention is not limited to these.

### Embodiment 1

One embodiment of the present invention will be described below.

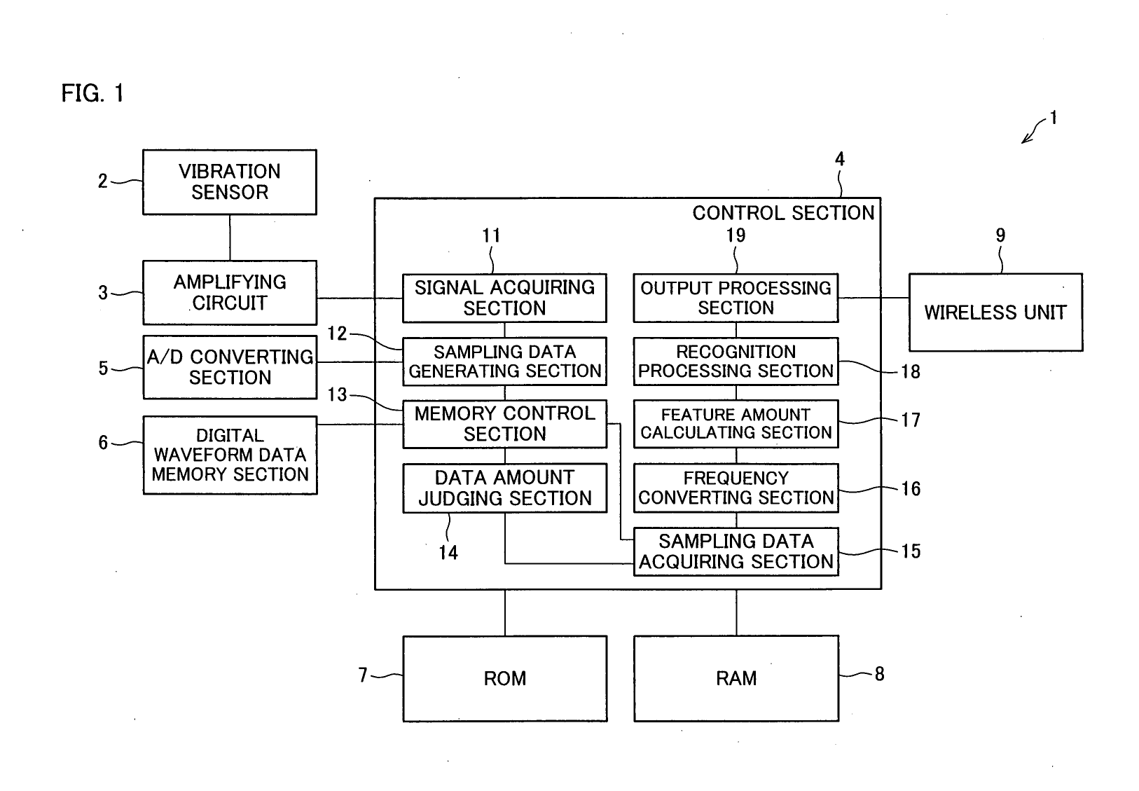

FIG. 1 is a block diagram schematically illustrating a vehicle wheel stealing detecting apparatus 1 according to the present embodiment. The vehicle wheel stealing detecting apparatus 1 is provided in a vehicle so as to detect vibrations caused by an action of removing a vehicle wheel (a wheel and/or a tire) from the vehicle. More specifically, the vehicle wheel stealing detecting apparatus 1 distinguishes between (i) a vibration due to shaking of the vehicle's body caused by a tire movement occurring when unfixing and removing nuts (fixing means) from the wheel by turning each of the nuts, and (ii) a vibration due to other factors, and detects the vibration (i).

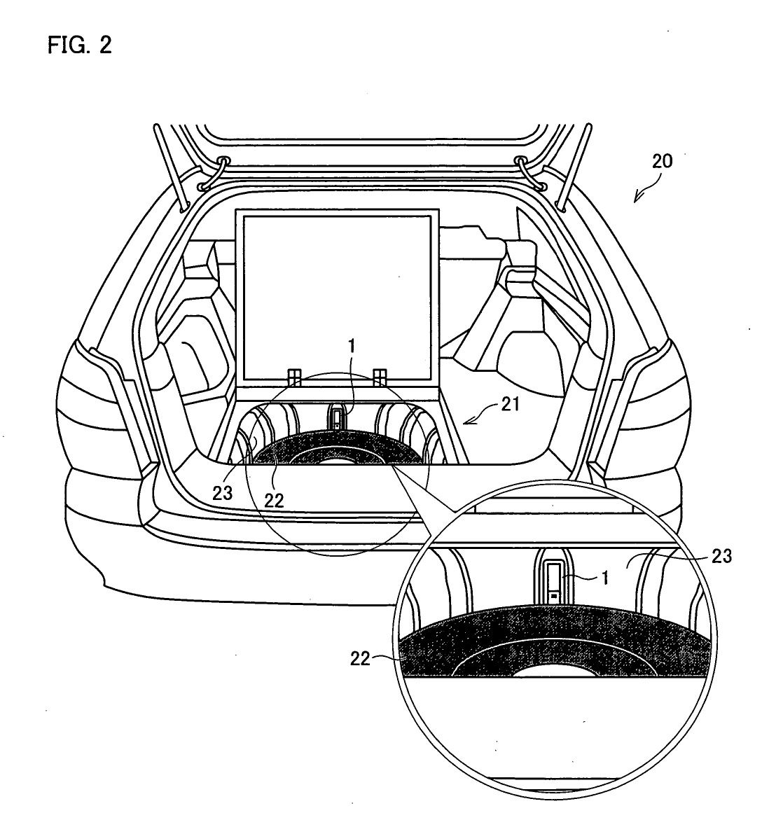

As shown in FIG. 2, the vehicle wheel stealing detecting apparatus 1 has an elongate shape (substantially rectangular shape), and is provided in a metal portion 23 surrounding a tire house 21 that is provided under a trunk space of an automobile (vehicle) 20, and that fixes a spare tire 22. More specifically, the vehicle wheel stealing detecting apparatus 1 is provided with a magnet (strong magnet; not shown), and is fixed to the aforementioned metal portion by way of magnetic power of the magnet.

As shown in FIG. 1, the vehicle wheel stealing detecting apparatus 1 includes a vibration sensor (vibration measuring means) 2, an amplifying circuit 3, a control section 4, an A/D converting section (A/D converting means) 5, a digital waveform data memory section (memory means) 6, a ROM 7, a RAM 8, and a wireless unit 9. The control section 4 includes a signal acquiring section 11, a sampling data generating section (A/D converting section) 12, a memory control section 13, a data amount judging section (digital signal acquiring means) 14, a sampling data acquiring section (digital signal acquiring means) 15, a frequency converting section (frequency converting means) 16, a feature amount calculating section (feature amount acquiring means) 17, a recognition processing section (recognition processing means) 18, and an output processing section 19. That is, the control section 4 reads out a program stored in the ROM 7, and executes the program so as to realize respective below-described functions of the signal acquiring section 11, the sampling data generating section 12, the memory control section 13, the data amount judging section 14, the sampling data acquiring section 15, the frequency converting section 16, the feature amount calculating section 17, the recognition processing section 18, and the output processing section 19.

The vibration sensor 2 detects a slight vibration of the vehicle. The vibration sensor 2 is connected to the amplifying circuit 3. The vibration sensor 2 converts a detection result into an electric signal, and sends the electric signal to the amplifying circuit 3.

The amplifying circuit 3 amplifies the signal, which is sent from the vibration sensor 2, up to a level at which the signal can be subjected to a recognition process. Then, the signal thus amplified is sent to the control section 4.

The control section (CPU; Central Processing Unit) 4 is a central portion of the vehicle wheel stealing detecting apparatus 1, and controls all the operations of the vehicle wheel stealing detecting apparatus 1. The control section 4 carries out various processes in accordance with the program stored in the ROM 7. Further, the control section 4 arbitrarily causes the RAM 8 to store data required for the execution of the processes, and reads out the stored data as required.

The signal acquiring section 11 provided in the control section 4 acquires the analog signal, which is sent from the amplifying circuit 3 and which indicates a change of a vibration. Then, the signal acquiring section 11 supplies the analog signal to the sampling data generating section 12.

By using the A/D converting section 5, the sampling data generating section 12 converts (i) the analog signal supplied from the signal acquiring section 11, into (ii) a digital signal. In other words, the A/D (analog/digital) converting section 5 converts the signal supplied from the amplifying circuit 3, from (i) an analog value to (ii) a digital value. This allows generation of sampling data indicating the vibration. Then, the sampling data generating section 12 sends the generated sampling data to the memory control section 13.

The memory control section 13 causes the digital waveform data memory section 6 to store the sampling data supplied from the sampling data generating section 12. Further, the memory control section 13 reads out the sampling data from the digital waveform data memory section 6, and sends the sampling data to the data amount judging section 14.

The data amount judging section 14 judges a data amount of the sampling data, which is supplied from the memory control section 13 and which indicates the vibration. Then, the data amount judging section 14 notifies a result of the judgment to the sampling data acquiring section 15.

In accordance with the notification from the data amount judging section 14, the sampling data acquiring section 15 sequentially acquires the N-number of sampling data, which include sampling data stored most recently in the digital waveform data memory section 6, from the digital waveform data memory section 6. Then, the N-number of the sampling data thus acquired are sent to the frequency converting section 16.

The frequency converting section 16 sequentially converts, into frequency domain data, the N-number of the sampling data acquired by the sampling data acquiring section 15. Then, the frequency converting section 16 sends the frequency domain data to the feature amount calculating section 17. In other words, the frequency converting section 16 converts the sampling data from the time domain (spatial domain) to the frequency domain in accordance with, e.g., the FFT (fast Fourier transform), and then sends the converted data to the feature amount calculating section 17.

In accordance with the sampling data thus converted into the frequency domain data by the frequency converting section 16, the feature amount calculating section 17 calculates (extracts) feature amounts of the frequency domain. Then, a result of the calculation is sent to the recognition processing section (judging section) 18. The feature amounts thus extracted make it possible for the control section 4 to distinguish between (i) vibrations caused by, e.g., big wind, breaking of glass, crashing, opening/closing of a door, slapping sound, and the like, and (ii) the vibration caused by turning the nut (fixing means) fixing the wheel (vehicle wheel).

In accordance with the calculation result supplied from the feature amount calculating section 17, the recognition processing section 18 carries out a recognition process, i.e., a process of finding whether or not abnormality has been detected. When the recognition processing section 18 recognizes that the abnormality has been detected, the recognition processing section 18 sends a control signal to the output processing section 19.

The output processing section 19 sends, to the wireless unit 9, an electric signal indicating a result of the judgment carried out by the recognition processing section 18.

When receiving, from the output processing section 19 (the control section 4), the signal indicating that the abnormality has been detected, the wireless unit 9 notifies (transmits) the abnormality to a predetermined external device. The external device may be, e.g., a device for carrying out threatening and warning operations by using a warning sound and a strobe flashlight. Alternatively, in order to notify the abnormality, a call may be made to a security system of a security company, a mobile phone of the owner of the vehicle, and/or the like via a telephone line or the like.

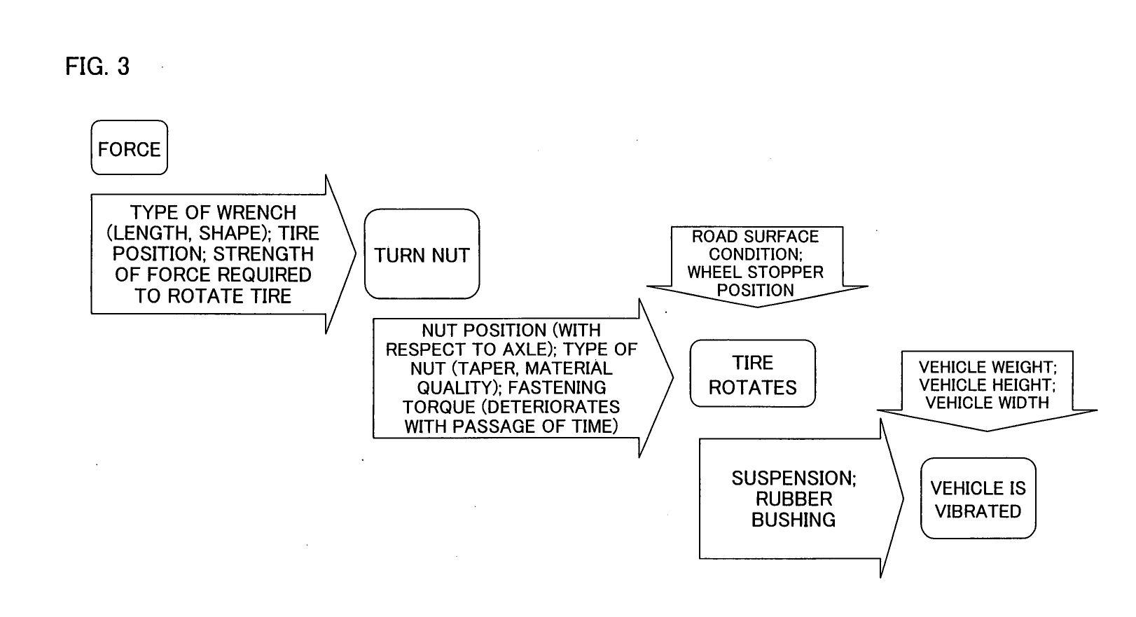

Explained here is a principle of how the vehicle wheel stealing detecting apparatus 1 carries out the stealing detection (abnormality detection). FIG. 3 is an explanatory diagram illustrating transfer of force exerted to unfix the nut of the wheel. As shown in FIG. 3, when the force is exerted to turn the nut, the force is transferred to the wheel and the tire via the nut, with the result that the tire is rotated. The force thus causing the rotation of the tire is transferred to the vehicle's body via a suspension, a rubber bushing, and the like, with the result that the vehicle's body is vibrated. Note that the strength of the force exerted on the nut differs depending on (i) a type (length and shape) of wrench (tool) used to turn the nut, (ii) the position of the tire, (iii) the strength of force (rotation resistance) required for the rotation of the tire, and the like. Note also that the strength of the force transferred from the nut to the wheel and the tire differs depending on (i) the position of the nut with respect to the axle (the rotation axis of the tire); (ii) a type (shape, and quality of a material) of the nut; (iii) a fastening torque, which possibly deteriorates with passage of time; (iv) a condition of a road surface with which the tire makes contact; (v) the position of a wheel stopper; and the like. Further, the vibration of the vehicle's body due to the force transferred from the wheel and the tire differs depending on (i) the weight of the vehicle; (ii) the height of the vehicle; (iii) the width of the vehicle; (iv) respective vibration transfer properties of members such as the suspension and the rubber bushing; and the like.

As such, the force exerted to turn the nut is transferred to the wheel and the tire, with the result that the force for rotating the tire is generated. The force for rotating the tire is transferred to the vehicle's body, with the result that the vehicle is vibrated. The vehicle wheel stealing detecting apparatus 1 detects this vibration. Therefore, the force for rotating the tire, and the property of transferring the force from the tire and the wheel to the vehicle's body are important factors that determine detection performance of the vehicle wheel stealing detecting apparatus 1.

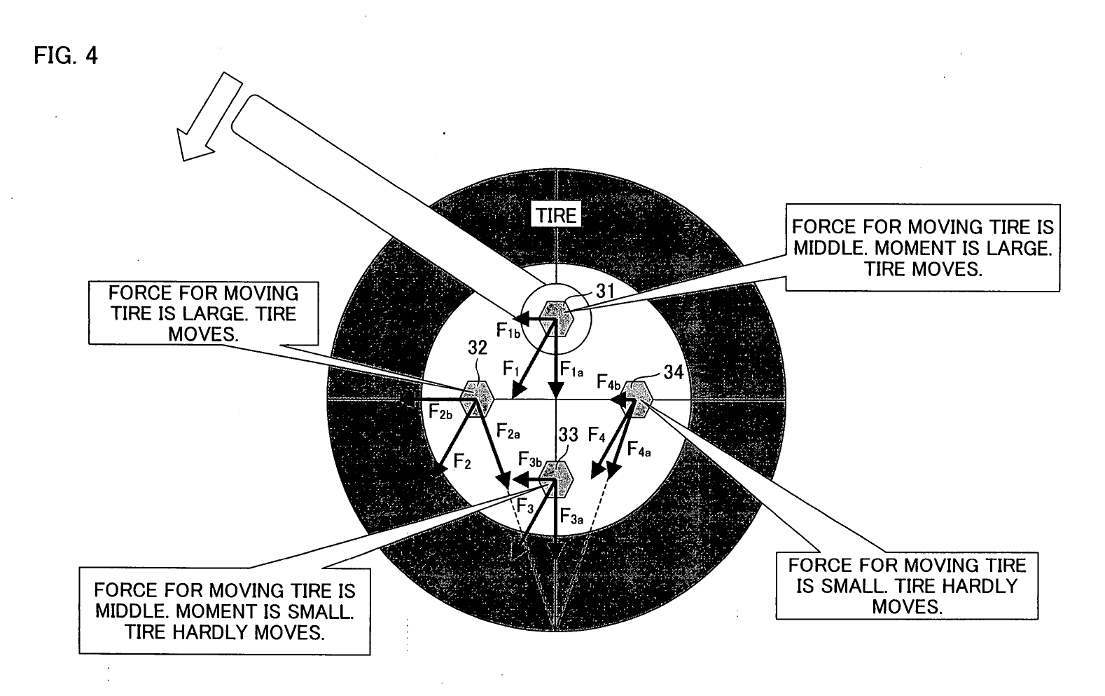

FIG. 4 is an explanatory diagram schematically illustrating a relation between (i) the position of each of the nuts and (ii) the strength of the force exerted from the wrench so as to turn each of the nuts, i.e., the strength of the force for rotating the tire (force for moving the tire).

See FIG. 4. Force F1 through F4 for turning nuts 31 through 34 is divided into (i) force F1a through F4a and (ii) force F1b through F4b, respectively. Each of force F1a through F4a is force of pressing the tire in the direction of a line connecting each of the nuts with a point at which the tire makes contact with the ground (hereinafter, the point is referred to as “tire contact point”). Each of the force F1b through F4b is the force for moving the tire. The force F1b through F4b for moving the tire causes rotation of the tire, with the result that the tire is moved from the ground contact point. Accordingly, the vehicle's body is vibrated.

For example, consider a case where the nut 31, which is positioned in the upper portion of the vehicle wheel above the tire contact point, is anti-clockwisely turned. In this case, the strength of the force for moving the tire is middle (medium) as compared with the strength of force required to turn the other nuts; however, a distance is long from the tire contact point to the nut 31, so that moment for rotating the tire is large. Therefore, the tire is moved.

Further, consider a case where the nut 32, which is positioned below the nut 31 in the anti-clockwise direction with respect to the center of the tire, is anti-clockwisely turned. In this case, the strength of the force for moving the tire is greater than the strength of force required to turn the other nuts, and moment for rotating tire is middle (medium), so that the tire is moved.

Further, consider a case where the nut 33, which is positioned in the lower side of the vehicle wheel above the tire contact point, is anti-clockwisely turned. In this case, the strength of the force for moving the tire is middle as compared with the strength of force required to turn the other nuts; however, a distance is short from the tire contact point to the nut 33, so that moment for rotating the tire is small. Therefore, the tire is hardly moved.

Further, consider a case where the nut 34, which is positioned above the nut 33 in the anti-clockwise direction with respect to the center of the tire, is anti-clockwisely turned. In this case, the strength of the force for moving the tire is smaller than the strength of force required to turn the other nuts, and moment for rotating the tire is middle. Therefore, the tire is hardly moved.

The strength of the force for turning each of the nuts differs depending on the type of nut (shape and material quality), the fastening torque of the nut, the position of the nut with respect to the axle, the type of wrench (length, shape, etc.), and the like. The force for turning the nut causes generation of the force for rotating the tire, so that the force for rotating the tire depends on the above factors.

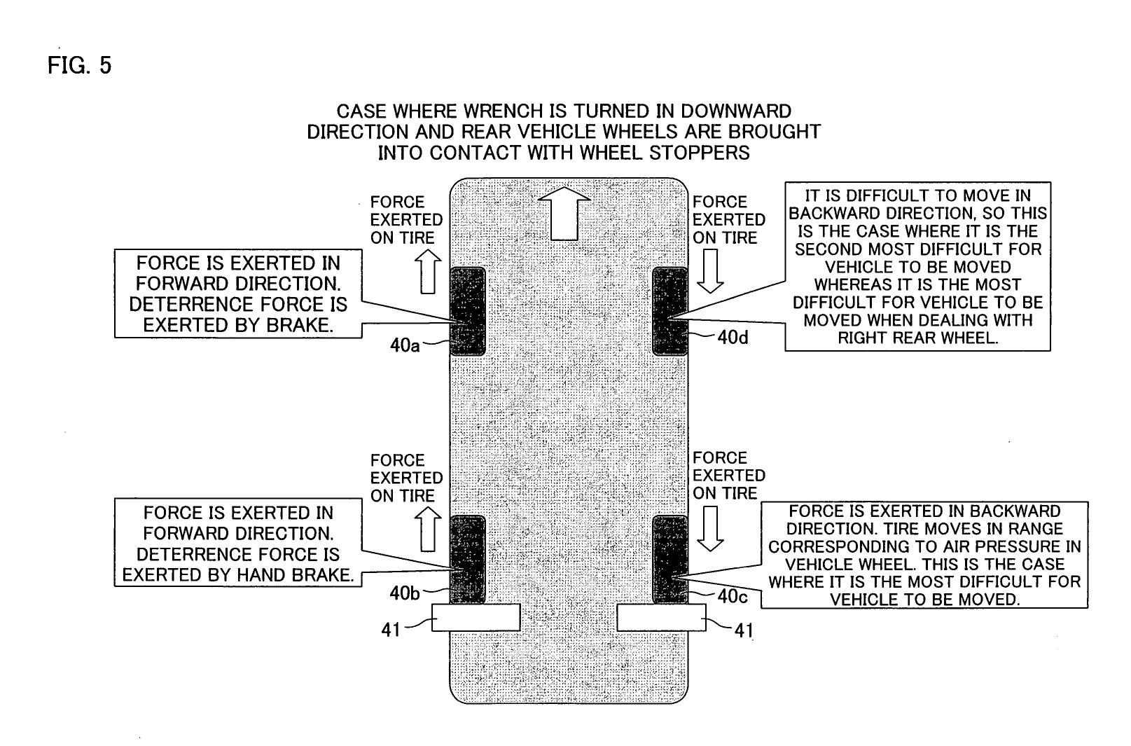

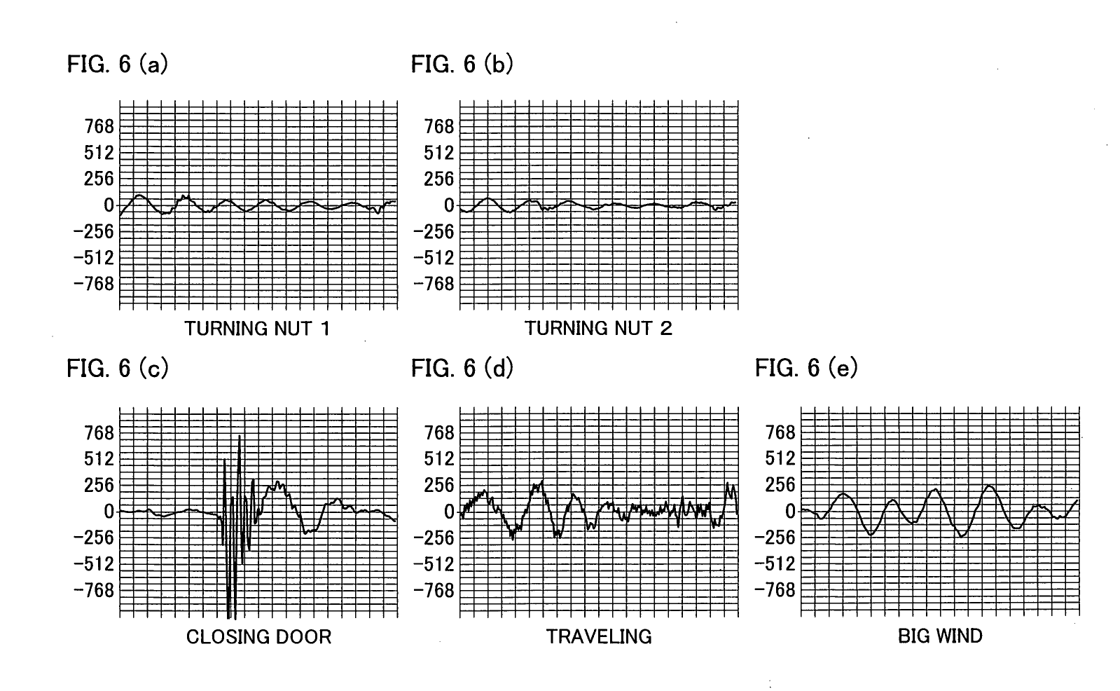

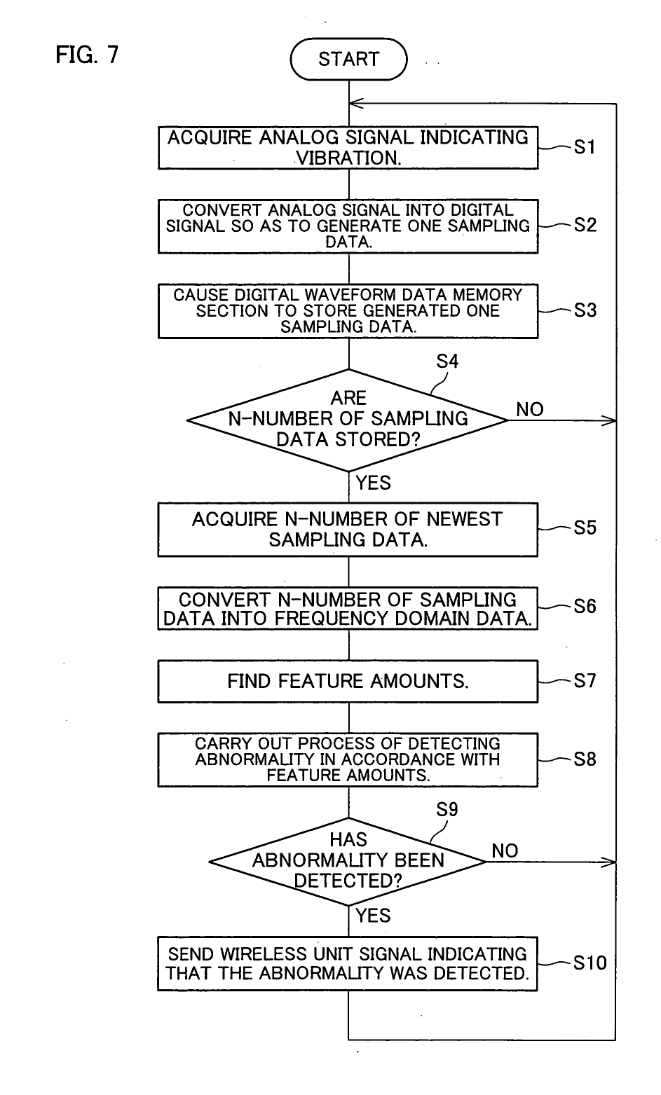

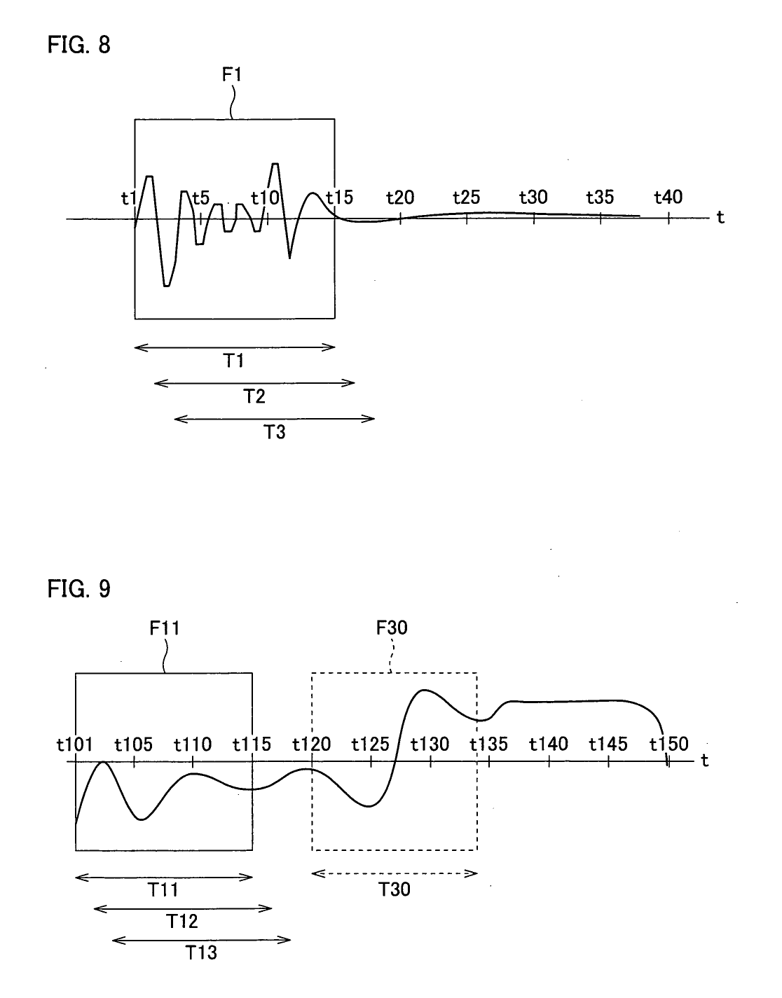

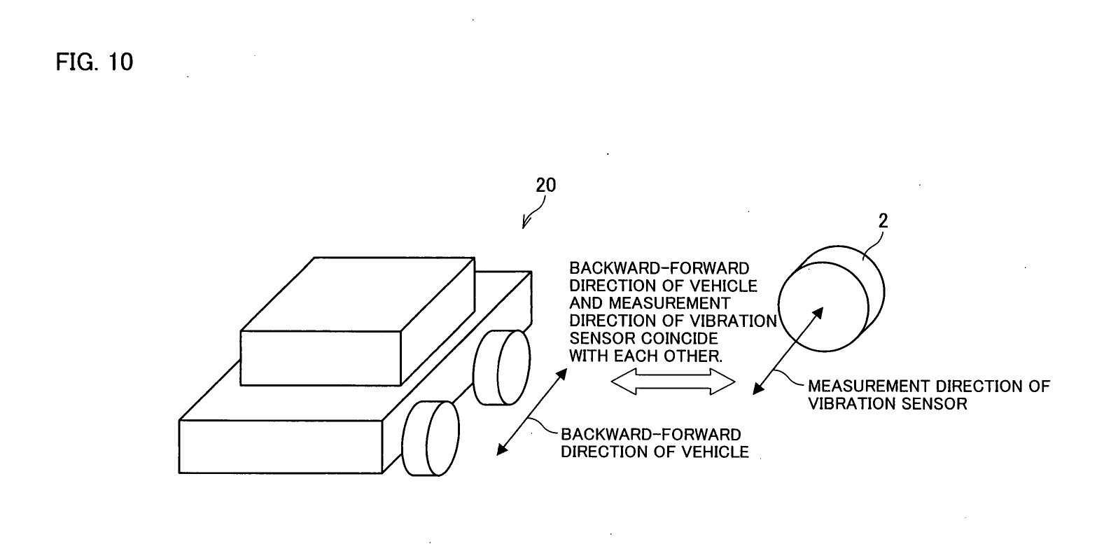

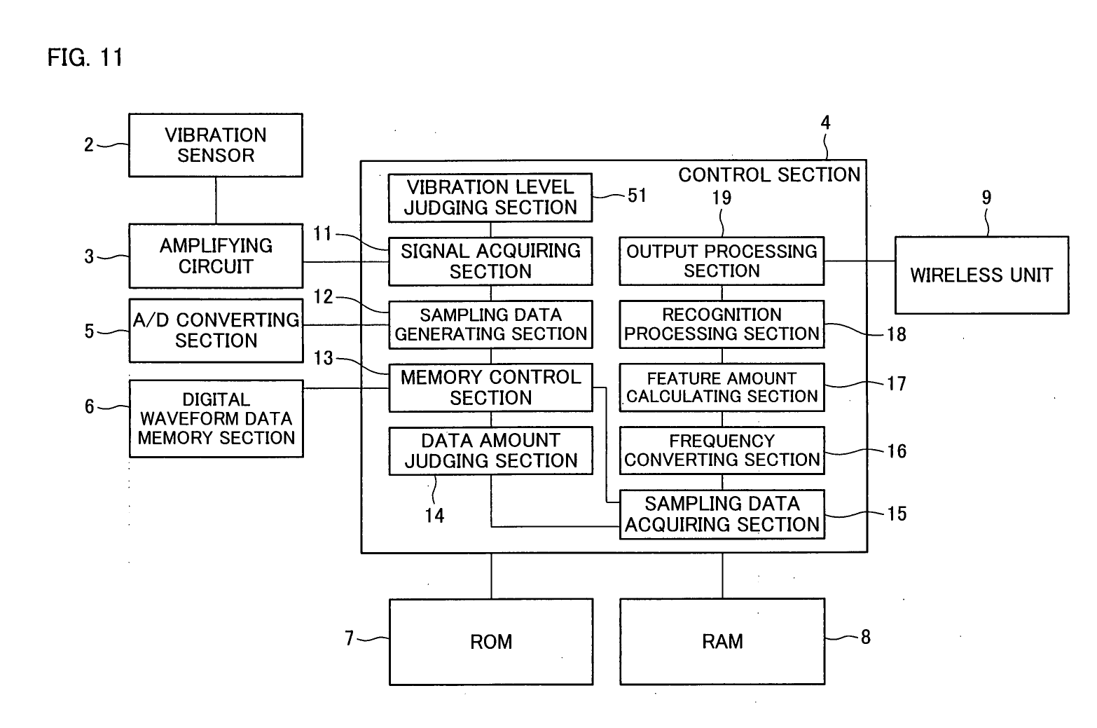

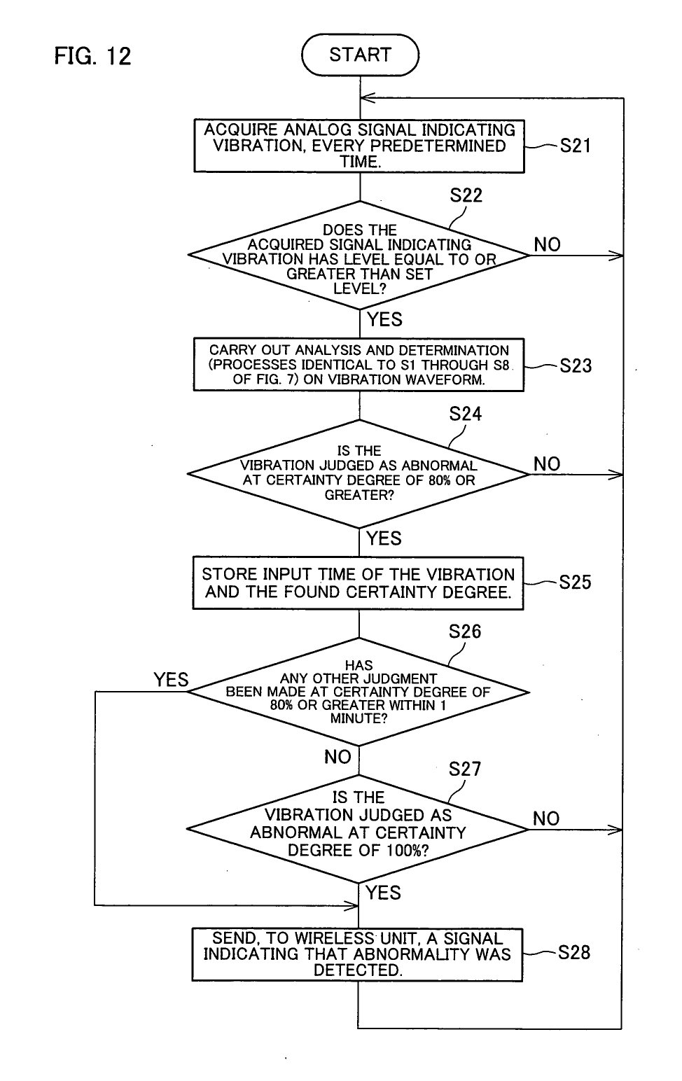

Further, the strength of force for rotating front tires, and the strength of force for rotating rear tires are different from each other. The strength of force for rotating tires positioned in the left side of the vehicle, and the strength of force for rotating tires positioned in the right side of the vehicle are different from each other. The strength of the force for rotating each of the tires differs depending on the position of the tire with respect to the wheel stopper. FIG. 5 is a plan view illustrating a relation between the position of each of the tires (vehicle wheels) and the vibration of the vehicle's body. Specifically, FIG. 5 illustrates a case where a left rear vehicle wheel 40b and a right rear vehicle wheel 40c are respectively brought into contact with wheel stoppers 41, and where the wrench is turned in the downward direction so as to turn each nut in the tires.

Exerted on a left front vehicle wheel 40a when turning a nut of the left front vehicle wheel 40a are (i) force for moving the tire in the forward direction (the direction in which the vehicle travels), and (ii) deterrence force due to a brake.

Exerted on the left rear vehicle wheel 40b when turning a nut of the left front vehicle wheel 40b are (i) force for moving the tire in the forward direction, and (ii) deterrence force due to a handbrake.

Exerted on a right front vehicle wheel 40d when turning a nut of the right front vehicle wheel 40d is force for moving the tire in the backward direction (direction opposite to the direction in which the vehicle travels). However, in this case, it is difficult for the vehicle to be moved in the backward direction. This is the case where it is the second most difficult for the vehicle to be moved, while it is the most difficult for the vehicle to be moved in the case of turning a nut of the right rear vehicle wheel 40c.

Exerted on the right rear vehicle wheel 40c when turning a nut of the right rear vehicle wheel 40c is force for moving the tire in the backward direction. In this case, the right rear vehicle wheel 40c moves in a range corresponding to air pressure in the vehicle wheel, so that it is the most difficult for the vehicle to be moved as compared with the cases of turning the nuts of the other vehicle wheels.

The force for rotating each of the tires finally causes generation of a slight vibration of the vehicle's body. The magnitude of the vibration of the vehicle's body differs depending on (i) the suspension connecting the tire system to the vehicle body system, (ii) a transferring system such as the rubber bushing, (iii) the weight of the vehicle, and the like. Each of these factors also works as force for restraining the vibration. Therefore, the transferring system and the weight of the vehicle are important factors in stopping the vibration having occurred.

Each of FIG. 6(a) through FIG. 6(e) is a graph illustrating a result of measuring a vibration (vehicle body vibration) of the vehicle's body by using the vibration sensor 2. Specifically, FIG. 6(a) illustrates a vibration waveform of vehicle body vibration caused by turning a nut and measured by the vibration sensor 2. FIG. 6(b) is a vibration waveform of vehicle body vibration caused when turning a nut different from the nut of FIG. 6(a). FIG. 6(c) illustrates a vibration waveform of vehicle body vibration caused when closing a door of the vehicle. FIG. 6(d) illustrates a vibration waveform of vehicle body vibration occurring during traveling (driving). FIG. 6(e) illustrates a vibration waveform of vehicle body vibration caused by big wind while the vehicle is parked. Each of FIG. 6(a) through FIG. 6(e) has (i) a horizontal axis representing passage of time, and (ii) a vertical axis representing an amplitude of the vibration.

See FIG. 6(a) through FIG. 6(e). Although it is impossible to precisely judge the shape of each waveform by merely viewing the waveform along the time axis, the waveform of the vehicle vibration caused upon turning the nut (each of FIG. 6(a) and FIG. 6(b)) has a low frequency and gradually attenuates, so that the waveform thereof has a specific tendency different from those of the vibration waveforms of the other measurement results (FIG. 6(c) through FIG. 6(e)). In other words, a tendency similar to the tendency of the waveform of the vehicle vibration caused upon turning the nut cannot be found in any waveforms of (i) the vibration naturally caused by the big wind or the like, (ii) the vibration caused by the traveling, (iii) the vibration caused by opening and/or closing the door, and the like.

Normally, firstly in stealing a tire and/or a wheel from a vehicle whose tires make contact with the ground, four through six nuts fixing an axle and the tire together are likely to be unfixed by a wrench. In this case, force for unfixing each of the nuts (force for turning the nut) is partially transferred to the tire, with the result that the tire is rotated. This causes the vehicle to be stirred back and forth. Further, the unfixing causes generation of force for pressing down the tire toward the ground, with the result that the tire is stirred vertically. This movement is transferred to the vehicle's body, with the result that the vehicle's body is slightly vibrated. The vibration thus caused is absorbed by the suspension of each of the four vehicle wheels (all the wheels), so that the vibration is gradually attenuated. The vehicle body vibration has such a characteristic. In the vehicle wheel stealing detecting apparatus 1 according to the present embodiment, the vibration sensor 2 fixed to the vehicle's body measures such a characteristic vehicle body vibration, and distinguishes the vehicle body vibration from the vibrations caused by the other factors, and detects the characteristic vibration. In this way, abnormality caused by the action of stealing the wheel is detected. In other words, when the measured vibration coincides with the characteristic vibration caused by turning the nut, the measured vibration is regarded as the abnormality caused by the action of stealing the vehicle wheel (the tire and/or the wheel).

The following explains how data processing for detecting the abnormality is carried out in the vehicle wheel stealing detecting apparatus 1, with reference to FIG. 7. FIG. 7 is a flowchart illustrating the flow of the data processing in the vehicle wheel stealing detecting apparatus 1 (control section 4).

Firstly, the signal acquiring section 11 (control section 4) acquires a time domain analog signal, which is supplied from the amplifying circuit 3 and which indicates a vibration (S1).

Next, the sampling data generating section 12 (control section 4) controls the A/D converting section 5 to convert the analog signal to a digital signal, with the result that one sampling data (sampling data indicating the vibration) is generated (S2). For example, see FIG. 8. In cases where the analog signal corresponding to time t1 is supplied, the sampling data generating section 12 causes the A/D converting section 5 to convert (i) the analog signal corresponding to the time t1, into (ii) a digital signal. This causes generation of one sampling data corresponding to the time t1.

The memory control section 13 (control section 4) causes the digital waveform data memory section 6 to store the one sampling data generated by the sampling data generating section 12 (in this case, the sampling data corresponding to the time t1) (S3).

Next, the data amount judging section 14 (control section 4) judges whether or not the N-number of sampling data are stored in the digital waveform data memory section 6 (S4). (The N-number of the sampling data corresponds to one frame.) Here, “N” may be any number; however, the present embodiment assumes that “N” is 15. In the case where “N” is 15, the data amount judging section 14 judges whether or not 15 sampling data are stored in the digital waveform data memory section 6. Specifically, when the number of the sampling data stored in the digital waveform data memory section 6 is less than 15, the data amount judging section 14 judges “NO”. On the other hand, when the number of the sampling data stored in the digital waveform data memory section 6 reaches 15, the data amount judging section 14 judges “YES”.

In cases where the data amount judging section 14 judges that the N-number of the sampling data have not been stored in the digital waveform data memory section yet (NO in S4), the control section 4 repeats the processes from S1. Specifically, in S1, the signal acquiring section 11 acquires an analog signal supplied next from the amplifying circuit 3. In S2, the sampling data generating section 12 controls the A/D converting section 5 to convert (i) the analog signal acquired by the signal acquiring section 11, into (ii) a digital signal. This causes generation of second sampling data. In this case, an analog signal corresponding to time t2 is converted into the digital signal.

Here, by causing the A/D converting section 5 to convert analog signals to digital signals at a certain timing cycle (a cycle of time “t2-t1” in the case of FIG. 8), i.e., by repeating S2, a plurality of sampling data can be obtained. The cycle (the cycle of the time t2-t1 in the case of FIG. 8) is a cycle found in accordance with the sampling theorem and corresponding to a frequency of not less than 100 Hz in cases where each analog signal to be detected has a maximum frequency of 50 Hz.

By repeating S1 through S4, the sampling data are sequentially stored in the digital waveform data memory section 6.

In the meanwhile, when it is judged in S4 that the N-number of sampling data are stored in the digital waveform data memory section 6 (N is 15 in the present embodiment, so that the processes S1 through S4 are repeated for 15 times, and 15 sampling data are stored in the digital waveform data memory section 6), the sampling data acquiring section 15 (control section 4) acquires, among the plurality of the sampling data stored in the digital waveform data memory section 6, the N-number of the sampling data including sampling data most recently stored in the digital waveform data memory section 6 (the newest one sampling data stored therein as a result of the most recent process S3) (S5). In this way, the sampling data acquiring section 15 (control section 4) sequentially acquires, from the sampling data stored in the digital waveform data memory section 6, the sampling data that include the most recently measured sampling data indicating a vibration, and that respectively have predetermined data amounts.

Specifically, in cases where N is 15 as with the present embodiment, the sampling data acquiring section 15 acquires 15 sampling data during times t1 through t15 of a period T1 of the frame F1 as shown in FIG. 8. The newest sampling data is sampling data corresponding to the time t15.

Next, the N-number (15 in the present embodiment) of the time domain sampling data acquired by the sampling data acquiring section 15 and corresponding to one frame are converted by the frequency converting section 16 (control section 4) into the frequency domain data (S6). The conversion to the frequency domain data by the frequency converting section 16 may be carried out in accordance with, e.g., either the Fast Fourier Transform or the DCT (Discrete Cosine Transform). In the present embodiment, the DCT conversion method is adopted. In this case, 16 frequency domain data (DCT coefficients) DCT0 through DCT15 are generated.

Next, the feature amount calculating section 17 (control section 4) finds (extracts) feature amounts in accordance with the frequency domain data generated by the frequency converting section 16 (S7). In the present embodiment, the DCT coefficients DCT0 through DCT 15 are obtained. Therefore, in accordance with the DCT coefficients DCT0 through DCT15, the feature amount calculating section 17 finds the M-number of feature amounts.

Assume that M is 4 (four feature amounts are found), for example. The feature amount calculating section 17 finds, as a feature amount 1 (first feature amount), an average value of DCT coefficients indicating a direct current component (25 Hz or less in the present embodiment); and finds, as a feature amount 2 (second feature amount), an average value of DCT coefficients indicating the second lowest frequency component (25 Hz to 50 Hz in the present embodiment); and finds, as a feature amount 3 (third feature amount), an average value of DCT coefficients indicating the third lowest frequency component (50 MHz to 100 MHz in the present embodiment); and finds, as a feature amount 4 (fourth feature amount), an average value of DCT coefficients indicating a high frequency component (100 Hz or higher). Note that the range of each of the frequency components of the feature amounts may be changed according to conditions such as (i) the type of nut (shape and material quality), (ii) the fastening torque of the nut, and (iii) the position of the nut with respect to the axle.

Next, the recognition processing section 18 (control section 4) carries out the recognition process (process of detecting abnormality) in accordance with the feature amounts (feature amounts 1 through 4 in the present embodiment) found by the feature amount calculating section 17 (S8). For example, when the feature amount 1 is five or greater times larger than the feature amount 4, the recognition processing section 18 judges that abnormality has occurred. When the feature amounts 2 through 4 respectively exceed the reference values, the recognition processing section 18 may judge that the vibration is not abnormal but noise (vibration due to factors other than the turning of the nut), so that it is not judged that abnormality has occurred. Further, when it is confirmed, in reference to a history of feature amounts 2, that ⅕ attenuation has occurred during a certain period of time, the recognition processing section 18 may judge that abnormality has occurred. Further, a final judgment may be carried out in accordance with the combinations of the above rules, whether or not abnormality has occurred. The combinations of the above rules are made in consideration of priority. Further, in accordance with any one of the above judgment rules or some of the above judgment rules, a certainty degree of judging (determining) that the vibration is caused due to the turning of the nut may be found. When the certainty degree is equal to or higher than a predetermined value (e.g., 80%), it may be judged that abnormality has occurred. These methods make it possible to precisely distinguish between (i) the vibration caused due to the action of removing a wheel from the vehicle, and (ii) the vibrations caused due to the other factors.

Then, the recognition processing section 18 (control section 4) judges whether or not the abnormality has been detected by the recognition process (S9). When no abnormality has been detected (NO in S9), the control section 4 repeats the processes from S1.

Specifically, the signal acquiring section 11 acquires a next analog signal (corresponding to time t16 in the case of FIG. 8), and then the sampling data generating section 12 causes generation of one sampling data in the process S2, and the generated one sampling data is stored in the digital waveform data memory section 6 in the process S3. In this case, the digital waveform data memory section 6 stores 16 sampling data, so that it is judged in the process S4 that the N-number of sampling data are stored in the digital waveform data memory section 6 (it is judged “YES”).

In the process S5, from the sampling data stored in the digital waveform data memory section 6, the sampling data acquiring section 15 acquires the N-number of the sampling data including the sampling data most recently stored therein in the process S4 coming just before the process S5. Acquired in this case are the 15 sampling data corresponding to times t2 through t16 of a period T2 of a frame F2 (not shown). Note that the memory control section 13 (control section 4) may be so arranged as to delete the sampling data (sampling data corresponding to the time t1 in this example) stored before the N-number of the sampling data including the sampling data stored most recently in the digital waveform data memory section 6.

Then, the 15 sampling data are converted into frequency domain data (DCT coefficients), and feature amounts are found in accordance with the DCT coefficients, and then the recognition process is carried out. After that, the same processes as described above are repeated.

In the meanwhile, when the recognition processing section 18 detects the abnormality (YES in S9), the recognition processing section 18 (control section 4) sends, to the output processing section 19, a control signal indicating that the abnormality has been detected. When the output processing section (control section 4) 19 receives, from the recognition processing section 18, the control signal indicating that the abnormality has been detected, an electric signal indicating that the abnormality has been detected is sent to the wireless unit 9 (S10) so as to cause the wireless unit 9 to transmit (notify), to a predetermined external device, a signal (abnormality notification signal) for notifying the occurrence of the abnormality.

Thereafter, the control section 4 repeats the processes from S1, as with the case where no abnormality is found in S9. Note that the vehicle wheel stealing detecting apparatus 1 may be provided with, e.g., either (i) a switch (not shown) for turning ON/OFF a power source supplying power to the respective sections, or (ii) a switch (not shown) for use in an ON/OFF operation for starting/stopping the abnormality detecting process carried out by the control section 4, and the control section 4 terminates the processes when each of the switch is turned OFF.

As described above, the vehicle wheel stealing detecting apparatus 1 is arranged as follows. That is, the vibration sensor 2 measures the vibration of the vehicle. The result of the measurement carried out by the vibration sensor 2 is converted into the frequency domain data by the frequency conversion section 16. The feature amount extracting section 17 extracts the plurality of feature amounts respectively corresponding to the frequency components of the frequency domain data. In accordance with the feature amounts thus extracted, the recognition processing section 18 distinguish (i) the vibration occurring in the vehicle due to the force of turning the nut fixing the wheel (vehicle wheel) to the vehicle, from (ii) the vibrations occurring therein due to the other factors. The vibrations (i) and (ii) are measured by the vibration sensor 2.

As such, the vibration occurring in the vehicle due to the force of turning the nut fixing the wheel to the vehicle can be distinguished from the vibrations occurring due to the other factors, so that the action of removing the vehicle wheel from the vehicle can be detected with high precision.

In the above description, the average value of the DCT coefficients indicating the direct current components (frequency band of 25 Hz or less in the present embodiment) is found as the feature amount 1 (first feature amount) by the feature amount calculating section 17; and the average value of the DCT coefficients indicating the second lowest frequency components (frequency band of 25 Hz to 50 Hz in the present embodiment) is found as the feature amount 2 (second feature amount); and the average value of the DCT coefficients indicating the third lowest frequency components (frequency band of 50 Hz to 100 Hz in the present embodiment) is found as the feature amount 3 (third feature amount); and the average value of the DCT coefficients indicating the high frequency components (frequency band of 100 Hz or higher) is found as the feature amount 4 (forth feature amount). However, the present invention is not limited to this. The range (frequency band) of each frequency component of the feature amounts, and the number of the feature amounts (the M-number) may be arbitrarily changed according to the conditions such as (i) the types of nut, (ii) the fastening torque of the nut, and (iii) the position of the nut with respect to the axle.

For example, the feature amount 1 may be a feature amount in a frequency band of 0 Hz to 25 Hz; and the feature amount 2 may be a feature amount in a frequency band of 25 Hz to 50 Hz; and the feature amount 3 may be a feature amount in a frequency band of 50 Hz to 100 Hz; and the feature amount may be a frequency amount in a frequency band of 100 Hz or higher. See another example. The range (first range) of the feature amount 1 may range from 0 Hz to 20 Hz, or may range from 5 Hz to 24 Hz. Likewise, the ranges (second range, third range, and forth range) of the feature amounts 2 through 4 may be changed within the aforementioned ranges, respectively.

Further, in the above description, when the feature amount 1 is a value five or greater times larger than the feature amount 4, it is judged that the abnormality has occurred. However, the multiplying factor of the feature amount 1 with respect to the feature amount 4 is not limited to this in terms of judging the occurrence of the abnormality. For judging the occurrence of the abnormality, the multiplying factor may be set arbitrarily according to the conditions such as the types (shape and material quality) of nut, the fastening torque of the nut, and the position of the nut with respect to the axle.

The above description explains the case where it is judged to be abnormal when the ⅕ attenuation is confirmed during the certain period of time in reference to the history of the feature amounts 2. However, the present invention is not limited to this. For judging the abnormality, the rate of the attenuation in the feature amount 2 may be set arbitrarily according to the conditions such as the types (shape and material quality) of nut, the fastening torque of the nut, and the position of the nut with respect to the axle.

Further, in the vehicle wheel stealing detecting apparatus 1, the A/D converting section 5 converts (i) the analog signal indicating the result of the measurement carried out by the vibration sensor 2 (analog signal amplified by the amplifying circuit 3), into (ii) the digital signal (sampling data). Then, the sampling data is stored by the digital waveform data memory section 6. From sampling data stored in the digital waveform data memory section 6, the sampling data acquiring section 15 sequentially acquires sampling data that respectively have predetermined data amounts and that include the sampling data indicating the vibration measured most recently. Then, the sampling data thus acquired by the sampling data acquiring section 15 are converted into the frequency domain data by the frequency converting section.

For example, as shown in FIG. 8, the vehicle wheel stealing detecting apparatus 1 firstly acquires the N-number of sampling data during the period T1 lasting from the time t1 to the time t15 and corresponding to the frame F1. Next, the N-number of sampling data are acquired during the period T2 lasting from the time t2 to the time t16 and corresponding to the frame F2. Further, the N-number of sampling data are acquired during the period T3 lasting from the time t3 to the time t17 and corresponding to the frame F3. In other words, the N-number of sampling data including one sampling data stored most recently are sequentially acquired in the vehicle wheel stealing detecting apparatus 1.

Therefore, even when a great change in the level of the vibration waveform occurs from a negative level to a positive level (or from the positive level to the negative level), the change portion can be surely detected (the change portion can be surely included in one frame). With this, each of the feature amounts found in the frequency domain data is restrained from being fluctuated due to the great level change. Therefore, the abnormality can be surely detected (recognized), i.e., the characteristics of the frequency domain data can be recognized.

For example, see FIG. 9. DCT coefficients are sequentially generated during (i) a period T11 lasting from time t101 to time t115 and corresponding to a frame F11, (ii) a period T12 lasting from the time t102 to time t116 and corresponding to a frame F12, (iii) a period T13 lasting from the time t103 to time t117, and the like. Therefore, for example, even in cases where the level of the amplitude of the vibration is greatly changed from the negative level to the positive level at a time t128, frames including the time t128 are generated (e.g., a frame F30 corresponding to a period T30 lasting from time t120 to time t134). This makes it possible that sampling data whose level in the waveform is greatly changed is included in one frame (that the change is less likely to occur over frames). Therefore, when the sampling data is converted into frequency domain data and calculation is carried out so as to find feature amounts thereof, the feature amounts are restrained from being fluctuated, so that abnormality can be surely detected (recognized) (the change in the frequency domain can be surely detected).

In the present embodiment, when one sampling data is generated, the newest N-number of sampling data are acquired. However, when not less than 1 but not more than the M-number (M is a natural number) of sampling data are generated, the N-number of sampling data including the most recent one may be sequentially acquired. In this case, the processes are carried out less frequently as compared with the case where the conversion to the frequency domain data is carried out every time one sampling data is acquired. This allows reduction of load to be imposed on the control section 4.

Further, in the present embodiment, the vehicle wheel stealing detecting apparatus 1 is installed in the metal portion surrounding the tire house 21 which is formed in the lower portion of the trunk space of the automobile and in which the spare tire is fixed, as shown in FIG. 2. However, the position in which the vehicle wheel stealing detecting apparatus 1 is installed is not limited to this. The sensor can be installed in any position as long as the sensor can measure the slight vibration of the vehicle. As such, the position in which the vehicle wheel stealing detecting apparatus 1 is installed is hardly limited in the vehicle, so that the degree of freedom is high in the installation of the vehicle wheel stealing detecting apparatus 1.

However, in cases where a member having a low rigidity is provided in a path via which vibration is transferred from the wheel to the vibration sensor 2 of the vehicle wheel stealing detecting apparatus 1, the vibration is absorbed by the member, with the result that the vibration is less likely to be detected appropriately. Therefore, for efficient detection of the vibration, it is preferable to install the vehicle wheel stealing detecting apparatus 1 in a portion to which vibration occurring in the vehicle's body is faithfully transferred. A specific example of the portion is metal portions constituting the body, such as (i) the metal portion surrounding the tire house 21, (ii) a portion which is formed in a trunk side or the like and which is used to contain and hold a jack, (iii) a metal anchor portion of a seat, (iv) inside of an engine room, (v) a vicinity of a gas tank. In cases where the vehicle wheel stealing detecting apparatus 1 is installed in an occupation space, which is occupied by a person on board, of the vehicle, it is preferable to install the vehicle wheel stealing detecting apparatus 1 in a position in which the vehicle wheel stealing detecting apparatus 1 is not moved or is not removed due to an operation of the person on board.

Further, in the present embodiment, the vehicle wheel stealing detecting apparatus 1 is installed with the use of the magnet in the metal portion surrounding the tire house 21. Therefore, the user can easily install the vehicle wheel stealing detecting apparatus 1. Further, the metal portion of the vehicle is provided in one piece with the metal portions constituting the body or is so provided as to be connected directly to the metal portions constituting the body, so that the vibration caused due to the force exerted on the vehicle is faithfully transferred to the metal portion. Therefore, the structure to be installed in the vehicle with the use of the magnet makes it possible to (i) prevent the user from installing the vehicle wheel stealing detecting apparatus 1 in an inappropriate position, and (ii) install the vehicle wheel stealing detecting apparatus 1 in an appropriate position. The vehicle wheel stealing detecting apparatus 1 is installed by using the magnet as such, so that the installation power is never deteriorated due to a temperature change or the like. With this, the detection can be carried out stably for a long period of time.

However, the method of installing the vehicle wheel stealing detecting apparatus 1 is not limited to this as long as the vibration of the vehicle's body is appropriately transferred thereto. For example, the vehicle wheel stealing detecting apparatus 1 can be installed by using, e.g., an adhesive agent, a double-faced adhesive tape (adhesive tape), or the like. In this case, the vehicle wheel stealing detecting apparatus 1 does not need to be installed in the metal portion, but may be installed in a resin material which has a high rigidity and via which the vibration of the vehicle's body is faithfully transferred. Further, in the case where the adhesive agent or the double-faced adhesive tape (adhesive tape) is used for the installation, it is preferable that the vehicle wheel stealing detecting apparatus 1 be made of a material having strong durability against an environmental change such as a temperature change and a humidity change. Further, it is preferable to install the vehicle wheel stealing detecting apparatus 1 in a position in which the temperature and the humidity are not bad.

Further, the direction in which the vibration sensor 2 is installed is not particularly limited; however, it is preferable that the vibration sensor 2 be installed so as to appropriately measure vibration of the vehicle in the backward-forward direction of the vehicle (the direction in which the vehicle travels). For example, in case of using a vibration sensor that carries out measurement in one direction, it is preferable that the vehicle wheel stealing detecting apparatus 1 be fixed and installed such that the measurement direction (measurement axis) of the vibration sensor coincides with the backward-forward direction of the vehicle. FIG. 10 is an explanatory diagram illustrating a relation between (i) the direction of the vehicle 20 in which the vehicle wheel stealing detecting apparatus 1 is provided, and (ii) the measurement direction (measurement axis) of the vibration sensor 2. In FIG. 10, the vehicle 20 is obliquely illustrated, and the sensor section of the vibration sensor 2 is illustrated in an enlarged manner.

The turning of the nut causes the movement of the tire, with the result that the vehicle is vibrated. Therefore, vibration for stirring the vehicle in the backward-forward direction of the vehicle is the strongest. In view of this, the measurement axis of the vibration sensor 2 is caused to coincide with the backward-forward direction in which the vehicle vibration caused by turning the nut is most efficiently measured. With this, even slight vibration is more likely to be detected.

Generally, the vehicle vibration caused by turning the nut is the strongest in the backward-forward direction of the vehicle, being the second strongest in the vertical direction of the vehicle, being the third strongest in the horizontal direction of the vehicle. Therefore, in cases where the vibration sensor 2 has a plurality of measurement axes, it is preferable that the measurement axes be caused to coincide with the backward-forward direction, the vertical direction, and the horizontal direction in this order. This makes it possible to measure relatively large vibration. For example, in cases where the vibration sensor 2 has two measurement axes, it is preferable that: one measurement axis be caused to coincide with the backward-forward direction of the vehicle, and the other measurement axis be caused to coincide with the vertical direction of the vehicle. Further, in cases where the vibration sensor 2 has three measurement axes or greater, it is preferable that three of the measurement axes be caused to coincide with the backward-forward direction, the vertical direction, and the horizontal direction of the vehicle, respectively.

Further, in the case where the vibration sensor 2 having the plurality of measurement axes is used, an axis in which the largest waveform of the vibration is obtained may be arbitrarily adopted according to a measurement result for the purpose of detecting abnormality. Further, detection algorithms may be used for the measurement axes, individually. In this case, more precise abnormal detection can be carried out.

In the present embodiment, the vehicle wheel stealing detecting apparatus 1 has a substantially rectangular shape; however, the shape of the vehicle wheel stealing detecting apparatus 1 is not particularly limited. However, the metal portions in the vehicle are normally provided with ribs allowing increase of the strength, or are in a wavy form. Therefore, it is preferable that the vehicle wheel stealing detecting apparatus 1 have a shape suitable for installation to such metal portions. Specifically, it is preferable that the vehicle wheel stealing detecting apparatus 1 have an elongate shape such as a rectangular shape and an elliptic shape.

The vibration sensor used in the present embodiment is a low frequency target vibration sensor for directly measuring vibration occurring in the vehicle; however, the vibration sensor is not limited to this. Even when a method using other measuring principles is used, the stealing of the vehicle wheel can be detected in the similar manner as that in the present embodiment, as long as (i) the detection target, i.e., the slight vehicle body vibration caused by turning the nut can be detected and (ii) the slight vehicle body vibration can be sufficiently distinguishable from other vibration and an influence of a sound.

For example, an acceleration sensor is provided instead of the vibration sensor so as to detect, in accordance with acceleration, the slight vibration caused by turning the nut.

Alternatively, a microphone that can detect a small sound is provided instead of the vibration sensor 2 so as to detect a characteristic sound caused by turning the nut. Examples of the characteristic sound (air vibration) include a sound caused inside or outside the vehicle.

Further, in the present embodiment, the result of the judgment carried out by the recognition processing section 18 (the detection result of the stealing of the vehicle wheel) is notified to the external device via the wireless unit 9; however, the present invention is not limited to this. For example, the signal may be transmitted to other devices connected to the vehicle wheel stealing detecting apparatus 1 via a cable, and control circuits of the devices may be driven for a threatening operation and a warning operation each using (i) sounds of a buzzer and a siren, and (ii) flashing of a flashing light. Further, the vehicle wheel stealing detecting apparatus 1 may include means for carrying out such threatening and warning operations, and the control section 4 may control operations of the means in accordance with the result of the judgment carried out by the recognition processing section 18.

In the present embodiment, the processes from (i) the acquisition of the analog signal from the amplifying circuit 3, to (ii) the sending of the judgment result to the wireless unit 9 are carried out by causing the control section 4 to read and execute the program stored in the ROM 7. Therefore, it is possible to say that the program allows realization of the processes.

Here, as an apparatus for reading out and executing the program, it is possible to use (i) a general computer (personal computer or the like); (ii) a function expansion board or a function expansion unit each connected to the computer; or the like. Further, the recording medium storing the program is not limited to the ROM, but may be a hard disk.

The above program refers to a program code (an executable program, an intermediate code program, a source program, or the like) which allows realization of the processes. The program may be used solely, or may be used in combination with other programs such as an OS.

The program may be read out from the recording medium, and then be temporarily stored in a memory (e.g., a RAM or the like) of the apparatus, and then be read out therefrom and executed. For example, reproducing means for reading out the program stored in the recording medium may be provided in the vehicle wheel stealing detecting apparatus 1 such that: the program is read out from the recording medium, and then the memory (RAM 8 or the like) of the apparatus is caused to store the program thus read out, and then the program is read out from the memory.

The recording medium storing the program may be easily detachable from the information processing apparatus (vehicle wheel stealing detecting apparatus 1), or may be fixed to the apparatus. Further, the recording medium may be connected to the apparatus as an external memory device.

Examples of such a program medium include a tape, such as a magnetic tape and a cassette tape; a magnetic disk, such as a floppy® disk and a hard disk; an optical disc (magnetic optical disc), such as a CD-ROM, an MO, an MD, a DVD, and a CD-R; a memory card, such as an IC card and an optical card; and a semiconductor memory, such as a mask ROM, an EPROM (erasable programmable read only memory), an EEPROM (electrically erasable programmable read only memory), or a flash ROM.

Further, a recording medium may be used which is connected to the information processing apparatus via a network such as an intranet and the Internet. In this case, the program is acquired by downloading the program via the network. In other words, the program may be acquired via a transmission medium (medium holding the program in a flowable manner) such as a network (cable network or wireless network). It is preferable that a program for carrying out the downloading be stored in advance in the apparatus (in a transmitting end apparatus or in a receiving end apparatus).

Further, the processes carried out by the control section 4 of the vehicle wheel stealing detecting apparatus 1 may be carried out not only in a time-series manner in the aforementioned order, but also in a parallel manner or an individual manner.

Further, the processes carried out by the control section 4 of the vehicle wheel stealing detecting apparatus 1 may be executed by software or hardware.

Explained in the present embodiment is the vehicle wheel stealing detecting apparatus 1, which distinguishes between (i) the vibration caused due to the action of removing a wheel from the vehicle (vibration occurring in the vehicle when turning nuts), and (ii) the vibration caused by the other factors, and which detects the vibration (i). However, the present invention is not limited to this. For example, vibration caused due to (i) breaking of a glass, (ii) picking of a lock of a door, (iii) scratching of the vehicle's body may be distinguished from the vibration caused by the other factors, and be detected.

Further, not only such human-induced abnormalities but also conditions such as a traveling condition, an engine condition, and a temperature can be detected.

Further, the vehicle in which the vehicle wheel stealing detecting apparatus 1 is provided is not limited to an automobile having four vehicle wheels. The vehicle wheel stealing detecting apparatus 1 may be provided in any vehicle having a vehicle wheel. Examples of the vehicle include: (i) an automobile having more than four vehicle wheels, such as a bus and a truck; (ii) an automatic two-wheeled vehicle; (iii) a bicycle; (iv) a monocycle; (v) a tricycle; and the like.

Further, it is possible to express that the object of the present invention is to realize an apparatus, which uses a low-frequency wave target vibration sensor so as to detect slight vibration of a vehicle caused due to the action of turning a nut of a vehicle wheel (a tire and/or a wheel) for the sake of stealing the vehicle wheel.

Further, it is possible to express that: the present invention was made in noticing that nuts are continuously turned upon stealing a vehicle wheel, and the object of the present invention is to realize a vehicle wheel stealing detecting apparatus allowing for less erroneous detection and high detection precision.

Further, the vehicle wheel stealing (removing) detecting apparatus of the present invention detects the slight vibration of the vehicle caused by turning the nuts, so that it is possible to monitor stealing of four vehicle wheels (all the vehicle wheels) with the use of one sensor.

Explained in the present embodiment is a case where the present invention is applied to the vehicle wheel stealing detecting apparatus 1 for use in preventing the vehicle wheel stealing; however, the present invention is also applicable to various types of information processing apparatus such as (i) various monitoring apparatuses each including a sensor, (ii) a measuring apparatus, and (iii) an analyzing apparatus.

### Embodiment 2

Another embodiment of the present invention will be described below. For ease of explanation, materials having the equivalent functions as those in the vehicle wheel stealing detecting apparatus 1 of Embodiment 1 will be given the same reference symbols, and explanation thereof will be omitted here.

The present embodiment allows improvement of accuracy in detecting abnormality, by using such a characteristic that nuts are continuously turned for the sake of stealing a vehicle wheel.

As described in Embodiment 1 with reference to FIG. 4 and FIG. 5, the magnitude of the vehicle body vibration differs depending on the position of each tire and the position of each nut. Accordingly, the ratio of detecting the abnormality differs depending on (i) the position of a nut to be turned, and (ii) the position of a wheel fixed by the nut.

However, at least all the nuts for one tire are removed for the sake of stealing a vehicle wheel (a tire and/or a wheel). That is, required for the removal of the wheel is the turning of all the nuts that fixes the wheel and that includes (i) nuts whose turning are detected with difficulty and (ii) nuts whose turning are detected with ease. In a normal case, these nuts are continuously removed (turned), so that vehicle body vibrations occur continuously due to the turning of each of the nuts.

Incorporated in light of this into the vehicle wheel stealing detecting apparatus is a logic by which it is judged “abnormal” upon occurrence of a series of vibrations which have the same tendency and each of whose detection is difficult due to low sensitivity of the vibration sensor. This allows improvement of detection performance of the vehicle wheel stealing detecting apparatus.

FIG. 11 is a block diagram illustrating a structure of such a vehicle wheel stealing detecting apparatus 1a according to the present embodiment. As shown in FIG. 11, the vehicle wheel stealing detecting apparatus 1a according to the present embodiment has the same structure as that of vehicle wheel stealing detecting apparatus 1 of Embodiment 1, except that the vehicle wheel stealing detecting apparatus 1a includes a vibration level judging section (vibration level judging means) 51 in the control section 4.

The vibration level judging section 51 judges whether or not an analog signal indicating a vibration change and sent from the vibration sensor 2 to the signal acquiring section 11 via the amplifying circuit 3 has a value equal to or larger than a predetermined set value. Only when the magnitude of the vibration indicated by the signal sent to the control section 4 (the signal acquiring section 11) is equal to or larger than the set value, the vehicle wheel stealing detecting apparatus 1a according to the present embodiment carries out an abnormality detecting process (judges whether or not the vibration indicated by the input signal has been caused by turning a nut).

Further, the vehicle wheel stealing detecting apparatus 1a according to the present embodiment judges that the vehicle body is vibrated by turning a nut, in the case of detecting, during a predetermined period, a plurality of vibrations each of whose values are equal to or larger than a predetermined value of an certainty degree of recognizing the abnormality.

The following explains data processing in the vehicle wheel stealing detecting apparatus 1a, with reference to FIG. 12. FIG. 12 is a flowchart illustrating a flow of the judging process carried out by the vehicle wheel stealing detecting apparatus 1a according to the present embodiment.

Firstly, every predetermined time, the signal acquiring section 11 (control section 4) acquires a time domain analog signal (vibration waveform) indicating a vibration and supplied from the amplifying circuit 3 (S21). Here, the interval (the predetermined time) between times, at which the signal acquiring section 11 acquires time domain analog signals, is not particularly limited; however, the signal acquiring section 11 acquires an analog signal every 1 second.

Next, the vibration level judging section 51 (control section 4) judges whether or not the level (amplitude) of the analog signal acquired by the signal acquiring section 11 and indicating the vibration is equal to or larger than the set level (set value) (S22). Here, the set level may be set in advance according to, e.g., (i) the position of a nut with respect to the axle, (ii) a type (shape and material quality) of nut, (iii) a fastening torque, (iv) a condition of a road surface with which the tires of the vehicle make contact, (v) the position of a wheel stopper, (vi) the weight of the vehicle, (vii) the height of the vehicle, (viii) the width of the vehicle, (ix) respective vibration transferring properties of members such as a suspension and a rubber bushing, (x) a sensitivity of the vibration sensor 2, and the like.

When the level of the analog signal indicating the vibration and acquired by the signal acquiring section 11 is smaller than the set level (NO in S22), the sequence goes back to S21. In other words, when the level of the analog signal indicating the vibration is not more than the set level, no judgment (analysis and determination) is carried out with respect to the waveform of the analog signal indicating the vibration. Then, every predetermined time, the signal acquiring section 11 keeps acquiring an analog signal indicating a vibration, and judgment is carried out whether or not the analog signal has a level equal to or greater than the set level.

In the meanwhile, in cases where the analog signal acquired by the signal acquiring section 11 and indicating the vibration has a level equal to or greater than the set level (YES in S22), the control section 4 carries out processes identical to the processes S1 through S8 shown in FIG. 7, and carries out analysis and determination of the vibration waveform (S23). In other words, in cases where it is judged that the level of the input signal indicating the vibration is equal to or greater than the set value, the analog signal indicating the vibration is converted into a digital signal, with the result that sampling data is generated. Then, the newest N-number of sampling data are converted into frequency domain data, and feature amounts of the frequency domain data are found. In accordance with the feature amounts thus found, the abnormality detecting process is carried out. In the present embodiment, the recognition processing section 18 (control section 4) gives priorities to a plurality of judgment criteria such as (i) how much times a feature amount 1 is larger than a feature amount 4 (e.g., the feature amount 1 is five or greater times larger than the feature amount 4); (ii) whether or not each of feature amounts 2 through 4 exceeds a reference value; and (iii) whether or not it is confirmed, in reference to the history of the feature amount 2, that ⅕ attenuation has occurred during a certain period. Then, the recognition processing section 18 combines the judgment criteria so as to find a degree of certainty of judging that the vibration subjected to the judgment is abnormal (the vibration subjected to the judgment is a vibration caused by turning a nut).

Further, the recognition processing section 18 (control section 4) judges whether or not the found certainty degree (the degree of certainty of judging that the vibration is abnormal) is equal to or greater than a predetermined value (80% in the present embodiment) (S24).

In cases where the certainty degree thus found is smaller than the predetermined value (80% in the present embodiment) (NO in S24), the control section 4 carries out the processes from S21.

In the meanwhile, in cases where the found certainty degree is equal to or greater than the predetermined value (80% in the present embodiment) (YES in S24), the recognition processing section 18 (control section 4) causes the RAM 8 (certainty degree memory section) 8 to store (i) time at which the vibration was detected, and (ii) the found certainty degree (S25). Specifically, when the vibration is judged abnormal at a certainty degree of 80% or greater, the recognition processing section 18 (control section 4) judges that the vibration is possibly abnormal one, and causes the RAM 8 to store (i) the time at which the vibration was detected, and (ii) the found certainty degree.

Further, the recognition processing section 18 (control section 4) reads out data from the RAM 8 so as to judge whether or not another vibration judged as an abnormal vibration at a certainty degree of 80% or greater has occurred within a predetermined period (1 minute in the present embodiment) from the present moment (S26).

Further, in cases where no vibration judged as an abnormal vibration has occurred during the predetermined period (NO in S26), the recognition processing section 18 (control section 4) judges whether or not the certainty degree found in S23 is 100% (S27).

In cases where the certainty degree found in S23 is not 100% (NO in S27), the control section 4 carries out the processes from S21. In other words, when a vibration is judged abnormal at a certainty degree of 80% or greater, the vehicle wheel stealing detecting apparatus 1a according to the present embodiment judges that the vibration is possibly an abnormal vibration; however, the vehicle wheel stealing detecting apparatus 1a does not judge immediately that abnormality has occurred, unless the certainty degree of the vibration is 100%.

On the other hand, in cases where the vibration judged as an abnormal vibration at a certainty degree of 80% or greater has occurred within the predetermined period (YES in S26) and where the certainty degree found in S27 is 100% (YES in S27), the recognition processing section 18 (control section 4) sends, to the output processing section 19, a control signal indicating that abnormality was detected. When the output processing section (control section 4) 19 receives, from the recognition processing section 18, the control signal indicating that the abnormality was detected, the output processing section 19 sends an electric signal to the wireless unit 9 so as to notify that the abnormality was detected (S28). Then, the wireless unit 9 transmits (notifies), to a predetermined external device, a signal (abnormality notification signal) for notifying the abnormality.

Thereafter, the control section 4 repeats the processes from S21. Note that the vehicle wheel stealing detecting apparatus 1a may be provided with, e.g., either (i) a switch (not shown) for turning ON/OFF a power source supplying power to the respective sections, or (ii) a switch (not shown) for use in an ON/OFF operation for starting/stopping the abnormality detecting process carried out by the control section 4, and the control section 4 terminates the processes when each of the switch is turned OFF.

As described above, in the vehicle wheel stealing detecting apparatus 1a according to the present embodiment, a vibration waveform (analog signal) is acquired from the vibration sensor 2 (amplifying circuit 3) every 1 second. Then, the vibration level judging section 51 judges whether or not the acquired analog signal indicating the vibration has a level equal to or larger than a set value. In cases where the level is not more than the set value, no vibration analysis (analysis and abnormality judgment on the vibration waveform) is carried out. Only in cases where the level is not less than the set value, the vibration analysis is carried out so as to judge whether or not the vibration indicated by the acquired analog signal is a vibration caused when turning a nut.

With this, the vibration analysis can be less frequently carried out, as compared with a case where the vibration analysis is always carried out. In the present embodiment, the acquisition of the analog signal indicating the vibration, and the judgment whether or not the level of the acquired analog indicating the vibration are carried out at an interval of 1 second; however, the present invention is not limited to this. The interval may be arbitrarily set according to processing speed of the control section (CPU) 4.

Further, in the vehicle wheel stealing detecting apparatus 1a according to the present embodiment, the recognition processing section 18 finds a degree of certainty of judging (determining) whether or not a target vibration is an abnormal vibration (the vibration is caused by turning a nut). In cases where the vibration is judged abnormal at a certainty degree of 100% and where one or more judgments have been made at a certainty degree of 80% or greater within 1 minute from the present moment, the recognition processing section 18 judges that the vibration is the vehicle body vibration caused by turning a nut. In other words, when a vibration is judged abnormal at a certainty degree of 80% or greater, the recognition processing section 18 judges that abnormality has possibly occurred; however, when the certainty degree is not less than 80% but not more than 100%, the recognition processing section 18 does not judge immediately that abnormality has occurred. The recognition processing section 18 judges that abnormality has occurred, only when another judgment has been made at a certainty degree of 80% within one minute from the present time. As such, even when a vibration is judged as abnormal at a certainty degree of 80% or greater, it is not judged immediately that abnormality has occurred. This makes it possible to reduce the number of erroneous detection of a vibration similar to an abnormal vibration. Further, when such vibrations that seem abnormal vibrations continuously occur, it is judged that abnormality has occurred. With this, the vehicle body vibration caused by turning a nut can be surely detected.

In the present embodiment, in cases where one or more judgments have been made at a certainty degree of 80% or greater within one minute from the present moment, it is judged that the vehicle body is vibrated by turning a nut; however, the certainty degree for the abnormality judgment is not limited to 80%, and may be, e.g., 70% or 90%. For example, a maximum effect can be exhibited by selecting, in reference to practical data, a value at which the number of erroneous detection is reduced and at which a vibration that seems an abnormal vibration is never missed out.

Further, the length of the period during which the history of the previous certainty degrees is referred is not limited to 1 minute, but may be, e.g., 30 seconds or 2 minutes.

It may be judged that abnormality has occurred, in cases where one or more judgments were respectively made at a certainty degree of 80% or greater within 1 minute from the present moment. Further, the number of the judgments previously made at the certainty degree may be set, as a criterion for judging that abnormality has occurred, so as to change according to the magnitude of a current certainty degree. For example, when two or more judgments have been made at a certainty degree of not less than 80%, or when one judgment has been made at a certainty degree of not less than 90%, it is judged that abnormality has occurred.

Further, in the present embodiment, when a vibration is judged abnormal at a certainty degree of 100%, it is judged that abnormality has occurred, irrespective of certainty degrees found previously. However, the present invention is not limited to this. For example, when the certainty degree is not less than 95% or not less than 98%, it may be judged that the abnormality has occurred, irrespective of the certainty degrees found previously.

The structure of the vehicle wheel stealing detecting apparatus 1a according to the present embodiment can be modified in the same manner as that of the vehicle wheel stealing detecting apparatus 1 of Embodiment 1 is. Further, the vehicle wheel stealing detecting apparatus 1a allows an effect substantially identical to the effect of the vehicle wheel stealing detecting apparatus 1 of Embodiment 1. Moreover, the vehicle wheel stealing detecting apparatus 1a is applicable to the apparatuses to which the vehicle wheel stealing detecting apparatus 1 is applicable.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

A vehicle wheel stealing detecting apparatus of the present invention, which is provided in a vehicle so as to detect an action of removing a vehicle wheel from the vehicle, includes: vibration measuring means for measuring a vibration of the vehicle; frequency converting means for converting (i) a result of the measurement carried out by the vibration measuring means, into (ii) frequency domain data; feature amount extracting means for extracting, from the frequency domain data, a plurality of feature amounts respectively corresponding to frequency bands; and recognition processing means for distinguishing, in accordance with the feature amounts, between (i) a vibration occurring in the vehicle due to force exerted to turn fixing means that fixes the vehicle wheel to the vehicle, and (ii) a vibration due to another factor.

Note that, the vehicle wheel stealing detecting apparatus may be arranged such that: the recognition processing section compares (i) a feature amount corresponding to a predetermined frequency band, with (ii) feature amounts respectively corresponding to frequency bands other than the frequency band, so as to distinguish (i) the vibration occurring in the vehicle due to the force exerted to turn the fixing means, and (ii) the vibration due to the other factor.

The vehicle wheel stealing detecting apparatus may be arranged such that: the feature amount extracting means extracts (i) a first feature amount corresponding to a frequency band of 0 Hz to 25 Hz, and (ii) a fourth feature amount corresponding to a frequency band of 100 Hz or greater, and when the first feature amount is predetermined times as large as the fourth feature amount, the recognition processing means judges that the vibration measured by the vibration measuring means is the vibration occurring in the vehicle due to the force exerted to turn the fixing means.

According to the above structure, it is possible to distinguish (i) the characteristic vibration occurring due to the turning of the fixing means, from (ii) the vibration occurring due to the other factor. Thus, the vibration caused due to the action of removing the vehicle wheel from the vehicle, and the vibration occurring due to the other factor can be distinguished from each other precisely.

Further, the vehicle wheel stealing detecting apparatus may be arranged such that: when a feature amount, corresponding to a predetermined frequency band, of the feature amounts attenuates to not more than a predetermined divisional number of the feature amount during a predetermined period, the recognition processing section judges that the vibration measured by the vibration measuring means is the vibration occurring in the vehicle due to the force exerted to turn the fixing means.

For example, the vehicle wheel stealing detecting apparatus may be arranged such that: the feature amount extracting means extracts a second feature amount corresponding to a frequency band of 25 Hz to 50 Hz, and when the second feature amount attenuates to not more than a predetermined divisional number of the second feature amount during a predetermined period, the recognition processing section judges that the vibration measured by the vibration measuring means is the vibration occurring in the vehicle due to the force exerted to turn the fixing means.

The above structure makes it possible to detect a characteristic way of attenuation of the vibration occurring due to the turning of the fixing means. Thus, the vibration occurring due to the action of removing the vehicle wheel from the vehicle, and the vibration occurring due to the other factor can be distinguished from each other precisely.

Further, the vehicle wheel stealing detecting apparatus may be arranged such that: when each of feature amounts, corresponding to frequency bands of a predetermined frequency or greater, of the feature amounts exceeds a reference value set in advance, the recognition processing means judges that the vibration measured by the vibration measuring means is the vibration occurring in the vehicle due to the force exerted to turn the fixing means.

The vehicle wheel stealing detecting apparatus may be arranged such that: the feature amount extracting means respectively extracts feature amounts of a plurality of frequency bands of 25 Hz or greater, and when each of the extracted feature amounts exceeds a reference value set in advance, the recognition processing means judges that the vibration measured by the vibration measuring means is caused due to the another factor.

According to the above structure, the vibration measured by the vibration measuring means can be recognized as the vibration caused due to the other factor. As such, the vibration occurring due to the action of removing the vehicle wheel from the vehicle can be precisely distinguished from the vibration occurring due to the other factor.

Further, the vehicle wheel stealing detecting apparatus may be arranged such that: the recognition processing means finds a certainty degree indicating how certain the vibration measured by the vibration measuring means is the vibration occurring in the vehicle due to the force exerted to turn the fixing means, and when the found certainty degree is equal to or larger than a predetermined value, the recognition processing means judges that the vibration measured by the vibration measuring means is the vibration occurring in the vehicle due to the force exerted to turn the fixing means.

With this, the vibration occurring due to the action of removing the vehicle wheel from the vehicle, and the vibration occurring due to the other factor can be distinguished more precisely.

The vehicle wheel stealing detecting apparatus may be arranged such that: the vibration measuring means measures a vibration occurring in a direction in which the vehicle travels.

The turning of the fixing means causes movement of the vehicle wheel, with the result that the vehicle is vibrated. In view of this, the direction of the vibration to be measured by the vibration measuring means is caused to coincide with the forward-backward direction of the vehicle. With this, the direction of the vibration to be measured by the vibration measuring means is a direction in which the vehicle's vibration occurring due to the turning of the fixing means can be detected most efficiently. As a result, even a slight vibration of the vehicle is more likely to be detected.

Further, the vehicle wheel stealing detecting apparatus may be arranged such that: in accordance with a plurality of vibrations differently occurring during a predetermined period, the recognition processing means distinguishes between (i) the vibration occurring in the vehicle due to the force exerted to turn the fixing means, and (ii) the vibration due to the another factor.

For example, the vehicle wheel stealing detecting apparatus may be arranged such that: the recognition processing means finds a certainty degree indicating how certain the vibration measured by the vibration measuring means is the vibration occurring in the vehicle due to the force exerted to turn the fixing means, and in cases where the found certainty degree is equal to or larger than a predetermined value and where a predetermined number of certainty degrees equal to or greater than the predetermined value have been obtained during a predetermined period, the recognition processing means judges that the vibration measured by the vibration measuring means is the vibration occurring in the vehicle due to the force exerted to turn the fixing means.

According to the above structure, the vibration occurring in the vehicle due to the force exerted to turn the fixing member, and the vibration occurring due to the other factor can be distinguished from each other in accordance with the plurality of vibrations differently measured during the period. With this, the action of removing the vehicle wheel from the vehicle can be detected more precisely.

Further, the vehicle wheel stealing detecting apparatus may further include: vibration level judging means for judging whether or not a magnitude of a vibration waveform found in accordance with the result of the measurement carried out by the vibration measuring means is equal to or larger than a set value, wherein: when the magnitude of the vibration waveform found in accordance with the result of the measurement carried out by the vibration measuring means is equal to or larger than the set value, the recognition processing means carries out a process of distinguishing between (i) the vibration occurring in the vehicle due to the force exerted to turn the fixing means, and (ii) the vibration occurring due to said another factor.

According to the above structure, the vibration analysis is less frequently carried out as compared with a case where the process is always carried out by the recognition processing means. This allows reduction of load on the recognition processing means.

Further, the vehicle wheel stealing detecting apparatus may further include: A/D converting means for converting (i) an analog signal indicating the result of the measurement carried out by the vibration measuring means, into (ii) a digital signal; memory means for storing the digital signal; and digital signal acquiring means for sequentially acquiring, from the memory means, digital signals which include a digital signal that indicates a vibration measured most recently and which have a predetermined data amount, wherein: the frequency converting means converts (i) the digital signals acquired by the digital signal acquiring means, into (ii) frequency domain data.

According to the above structure, even when a great level change occurred from a negative value to a positive value in a waveform of the vibrations measured by the vibration measuring means, the portion in which the change occurred can be surely detected in the waveform. With this, the feature amounts found from the converted frequency data are restrained from being fluctuated due to the great level change, so that the characteristic in the frequency data can be surely recognized.

A vehicle wheel stealing detecting method of the present invention for detecting an action of removing a vehicle wheel from a vehicle, the method includes the steps of: (A) causing vibration measuring means to measure a vibration of the vehicle; (B) converting (i) a result of the measurement carried out by the vibration measuring means, into (ii) frequency domain data; (C) extracting, from the frequency domain data, a plurality of feature amounts respectively corresponding to frequency bands; and (D) distinguishing, in accordance with the feature amounts, between (i) a vibration occurring in the vehicle due to force exerted to turn fixing means that fixes the vehicle wheel to the vehicle, and (ii) a vibration due to another factor.

According to the above method, the result of the measurement carried out by the vibration measuring means is converted into the frequency domain data; and the feature amounts respectively corresponding to the frequency bands are extracted from the frequency domain data; and the vibration occurring in the vehicle due to the force exerted to turn the fixing means that fixes the vehicle wheel to the vehicle, and the vibration due to the other factor are distinguished from each other in accordance with the feature amounts. This makes it possible to distinguish (i) the vibration occurring in the vehicle due to the force exerted to turn the fixing means, from (ii) the vibration occurring due to the other factor. Accordingly, the action of removing the vehicle wheel from the vehicle can be detected with high precision.

Note that, the method may be arranged such that: in the step (D), the vibration occurring in the vehicle due to the force exerted to turn the fixing means, and the vibration due to said another factor are distinguished from each other by comparing (i) a feature amount corresponding to a predetermined frequency band, with (ii) feature amounts respectively corresponding to frequency bands other than the frequency band.

According to the above method, it is possible to distinguish (i) the characteristic vibration occurring due to the turning of the fixing means, from (ii) the vibration occurring due to the other factor. Thus, the vibration caused due to the action of removing the vehicle wheel from the vehicle, and the vibration occurring due to the other factor can be distinguished from each other precisely.

Further, the method may be arranged such that: in the step (D), when a feature amount, corresponding to a predetermined frequency band, of the feature amounts attenuates to not more than a predetermined divisional number of the feature amount during a predetermined period, it is judged that the vibration measured by the vibration measuring means is the vibration occurring in the vehicle due to the force exerted to turn the fixing means.

The above method makes it possible to detect such a characteristic way of attenuation of the vibration occurring due to the turning of the fixing means. Thus, the vibration occurring due to the action of removing the vehicle wheel from the vehicle, and the vibration occurring due to the other factor can be distinguished from each other precisely.

The method may be arranged such that: in the step (D), when each of feature amounts, corresponding to frequency bands of a predetermined frequency or greater, of the feature amounts exceeds a reference value set in advance, it is judged that the vibration measured by the vibration measuring means is the vibration occurring in the vehicle due to the force exerted to turn the fixing means.

According to the above structure, the vibration measured by the vibration measuring means can be recognized as the vibration caused due to the other factor. As such, the vibration occurring due to the action of removing the vehicle wheel from the vehicle can be precisely distinguished from the vibration occurring due to the other factor.

Further, the method may be arranged such that: in the step (D), a certainty degree is found which indicates how certain the vibration measured by the vibration measuring means is the vibration occurring in the vehicle due to the force exerted to turn the fixing means, and when the found certainty degree is equal to or larger than a predetermined value, it is judged that the vibration measured by the vibration measuring means is the vibration occurring in the vehicle due to the force exerted to turn the fixing means.

With this, the vibration occurring due to the action of removing the vehicle wheel from the vehicle, and the vibration occurring due to the other factor can be distinguished from each other more precisely.

Further, the method may be arranged such that: in the step (A), a vibration occurring in a direction in which the vehicle travels is measured.

The turning of the fixing means causes movement of the vehicle wheel, with the result that the vehicle is vibrated. In view of this, the direction of the vibration to be measured by the vibration measuring means is caused to coincide with the forward-backward direction of the vehicle. With this, the direction of the vibration to be measured by the vibration measuring means is a direction in which the vehicle's vibration occurring due to the turning of the fixing means can be detected most efficiently. As a result, even a slight vibration of the vehicle is more likely to be detected.

Further, the method may be arranged such that: in the step (D), the vibration occurring in the vehicle due to the force exerted to turn the fixing means, and the vibration due to the another factor are distinguished from each other in accordance with a plurality of vibrations differently occurring during a predetermined period.

For example, the method may be arranged such that: in the step (D), a certainty degree is found which indicates how certain the vibration measured by the vibration measuring means is the vibration occurring in the vehicle due to the force exerted to turn the fixing means, and in cases where the found certainty degree is equal to or larger than a predetermined value and where a predetermined number of certainty degrees equal to or greater than the predetermined value have been obtained during a predetermined period, the recognition processing means judges that the vibration measured by the vibration measuring means is the vibration occurring in the vehicle due to the force exerted to turn the fixing means.

According to the above method, the vibration occurring in the vehicle due to the force exerted to turn the fixing member, and the vibration occurring due to the other factor can be distinguished from each other in accordance with the plurality of vibrations differently measured during the period. With this, the action of removing the vehicle wheel from the vehicle can be detected more precisely.

Further, the method may further include the step of: (E) judging whether or not a magnitude of a vibration waveform found in accordance with the result of the measurement carried out by the vibration measuring means is equal to or larger than a set value, wherein: in the step (E), when the magnitude of the vibration waveform is equal to or larger than the set value, a process is carried out so as to distinguish between (i) the vibration occurring in the vehicle due to the force exerted to turn the fixing means, and (ii) the vibration occurring due to the another factor.

According to the above method, the vibration analysis is less frequently carried out as compared with a case where the process in the step (D) is always carried out by the recognition processing means. This allows reduction of load on the recognition processing means.

A vehicle wheel stealing detecting program for causing a computer, provided in a vehicle wheel stealing detecting apparatus, to execute the process steps of any one of the methods described above.

By causing the computer to read the program, the process steps of the vehicle wheel stealing detecting method of the present invention can be realized in the computer.

Further, such a program is stored in a computer-readable recording medium, so that it is easy to store and distribute the program. Further, the computer reads the recording medium so as to carry out the process steps of the vehicle wheel stealing detecting method of the present invention.

(Effect of Invention)

As described above, a vehicle wheel stealing detecting apparatus of the present invention includes: vibration measuring means for measuring a vibration of the vehicle; frequency converting means for converting (i) a result of the measurement carried out by the vibration measuring means, into (ii) frequency domain data; feature amount extracting means for extracting, from the frequency domain data, a plurality of feature amounts respectively corresponding to frequency bands; and recognition processing means for distinguishing, in accordance with the feature amounts, between (i) a vibration occurring in the vehicle due to force exerted to turn fixing means that fixes the vehicle wheel to the vehicle, and (ii) a vibration due to another factor.

Further, a vehicle wheel stealing detecting method of the present invention includes the steps of: (A) causing vibration measuring means to measure a vibration of the vehicle; (B) converting (i) a result of the measurement carried out by the vibration measuring means, into (ii) frequency domain data; (C) extracting, from the frequency domain data, a plurality of feature amounts respectively corresponding to frequency bands; and (D) distinguishing, in accordance with the feature amounts, between (i) a vibration occurring in the vehicle due to force exerted to turn fixing means that fixes the vehicle wheel to the vehicle, and (ii) a vibration due to another factor.

With this, the vibration occurring in the vehicle due to the force exerted to turn the fixing means can be distinguished from the vibration occurring due to the other factor. Therefore, the action of removing the vehicle wheel from the vehicle can be precisely detected.

Further, a vehicle wheel stealing detecting program for causing a computer, provided in a vehicle wheel stealing detecting apparatus, to execute the process steps of the vehicle wheel stealing detecting method of the present invention.

By causing the computer to read the program, the process steps of the vehicle wheel stealing detecting method of the present invention can be realized in the computer.

Further, such a program is stored in a computer-readable recording medium, so that it is easy to store and distribute the program. Further, the computer reads the recording medium so as to carry out the process steps of the vehicle wheel stealing detecting method of the present invention.

### INDUSTRIAL APPLICABILITY

The present invention is applicable to a vehicle wheel stealing detecting apparatus for detecting stealing of a vehicle wheel from a vehicle. Here, the “vehicle” may be (i) an automobile having four vehicle wheels, (ii) an automobile having vehicle wheels more than four (e.g., a large-size car such as a bus or a truck), (iii) an automatic vehicle having two vehicle wheels, (iv) a bicycle, (v) a monocycle, (vi) a tricycle, or the like.

1. A vehicle wheel stealing detecting apparatus, which is provided in a vehicle so as to detect an action of removing a vehicle wheel from the vehicle,
said vehicle wheel stealing detecting apparatus, comprising:
vibration measuring means for measuring a vibration of the vehicle;
frequency converting means for converting (i) a result of the measurement carried out by the vibration measuring means, into (ii) frequency domain data;
feature amount extracting means for extracting, from the frequency domain data, a plurality of feature amounts respectively corresponding to frequency bands; and
recognition processing means for distinguishing, in accordance with the feature amounts, between (i) a vibration occurring in the vehicle due to force exerted to turn fixing means that fixes the vehicle wheel to the vehicle, and (ii) a vibration due to another factor,
the feature amount extracting means at least extracting (i) a first feature amount corresponding to a frequency band of 0 Hz to 25 Hz, and (ii) a fourth feature amount corresponding to a frequency band of 100 Hz or greater,
when the first feature amount is predetermined times as large as the fourth feature amount, the recognition processing means judging that the vibration measured by the vibration measuring means is the vibration occurring in the vehicle due to the force exerted to turn the fixing means.

2. (canceled)

3. (canceled)

4. The vehicle wheel stealing detecting apparatus, as set forth in claim 1, wherein:
when a feature amount, corresponding to a predetermined frequency band, of the feature amounts attenuates to not more than a predetermined divisional number of the feature amount during a predetermined period, the recognition processing section judges that the vibration measured by the vibration measuring means is the vibration occurring in the vehicle due to the force exerted to turn the fixing means.

5. The vehicle wheel stealing detecting apparatus as set forth in claim 4, wherein:
the feature amount extracting means extracts a second feature amount corresponding to a frequency band of 25 Hz to 50 Hz, and
when the second feature amount attenuates to not more than a predetermined divisional number of the second feature amount during a predetermined period, the recognition processing section judges that the vibration measured by the vibration measuring means is the vibration occurring in the vehicle due to the force exerted to turn the fixing means.

6. The vehicle wheel stealing detecting apparatus as set forth in claim 1, wherein:
when each of feature amounts, corresponding to frequency bands of a predetermined frequency or greater, of the feature amounts exceeds a reference value set in advance, the recognition processing means judges that the vibration measured by the vibration measuring means is the vibration occurring in the vehicle due to the force exerted to turn the fixing means.

7. The vehicle wheel stealing detecting apparatus as set forth in claim 6, wherein:
the feature amount extracting means respectively extracts feature amounts of a plurality of frequency bands of 25 Hz or greater, and
when each of the extracted feature amounts exceeds a reference value set in advance, the recognition processing means judges that the vibration measured by the vibration measuring means is caused due to said another factor.

8. The vehicle wheel stealing detecting apparatus as set forth in claim 1, wherein:
the recognition processing means finds a certainty degree indicating how certain the vibration measured by the vibration measuring means is the vibration occurring in the vehicle due to the force exerted to turn the fixing means, and
when the found certainty degree is equal to or larger than a predetermined value, the recognition processing means judges that the vibration measured by the vibration measuring means is the vibration occurring in the vehicle due to the force exerted to turn the fixing means.

9. The vehicle wheel stealing detecting apparatus as set forth in claim 1, wherein:
the vibration measuring means measures a vibration occurring in a direction in which the vehicle travels.

10. The vehicle wheel stealing detecting apparatus as set forth in claim 1, wherein:
in accordance with a plurality of vibrations differently occurring during a predetermined period, the recognition processing means distinguishes between (i) the vibration occurring in the vehicle due to the force exerted to turn the fixing means, and (ii) the vibration due to said another factor.

11. The vehicle wheel stealing detecting apparatus as set forth in claim 10, wherein:
the recognition processing means finds a certainty degree indicating how certain the vibration measured by the vibration measuring means is the vibration occurring in the vehicle due to the force exerted to turn the fixing means, and
in cases where the found certainty degree is equal to or larger than a predetermined value and where a predetermined number of certainty degrees equal to or greater than the predetermined value have been obtained during a predetermined period, the recognition processing means judges that the vibration measured by the vibration measuring means is the vibration occurring in the vehicle due to the force exerted to turn the fixing means.

12. The vehicle wheel stealing detecting apparatus as set forth in claim 1, further comprising:
vibration level judging means for judging whether or not a magnitude of a vibration waveform found in accordance with the result of the measurement carried out by the vibration measuring means is equal to or larger than a set value,
wherein:
when the magnitude of the vibration waveform found in accordance with the result of the measurement carried out by the vibration measuring means is equal to or larger than the set value, the recognition processing means carries out a process of distinguishing between (i) the vibration occurring in the vehicle due to the force exerted to turn the fixing means, and (ii) the vibration occurring due to said another factor.

13. The vehicle wheel stealing detecting apparatus as set forth in claim 1, further comprising:
A/D converting means for converting (i) an analog signal indicating the result of the measurement carried out by the vibration measuring means, into (ii) a digital signal;
memory means for storing the digital signal; and
digital signal acquiring means for sequentially acquiring, from the memory means, digital signals which include a digital signal that indicates a vibration measured most recently and which have a predetermined data amount,
wherein:
the frequency converting means converts (i) the digital signals acquired by the digital signal acquiring means, into (ii) frequency domain data.

14. A vehicle wheel stealing detecting method for detecting an action of removing a vehicle wheel from a vehicle,
said method, comprising the steps of:
(A) causing vibration measuring means to measure a vibration of the vehicle;
(B) converting (i) a result of the measurement carried out by the vibration measuring means, into (ii) frequency domain data;
(C) extracting, from the frequency domain data, a plurality of feature amounts respectively corresponding to frequency bands; and
(D) distinguishing, in accordance with the feature amounts, between (i) a vibration occurring in the vehicle due to force exerted to turn fixing means that fixes the vehicle wheel to the vehicle, and (ii) a vibration due to another factor,
in the step (C),
at least (i) a first feature amount corresponding to a frequency band of 0 Hz to 25 Hz, and (ii) a fourth feature amount corresponding to a frequency band of 100 Hz or greater being extracted,
in the recognition processing means
when the first feature amount is predetermined times as large as the fourth feature amount, it being judged that the vibration measured by the vibration measuring means is the vibration occurring in the vehicle due to the force exerted to turn the fixing means.

15. (canceled)

16. The method as set forth in claim 14, wherein:
in the step (D),
when a feature amount, corresponding to a predetermined frequency band, of the feature amounts attenuates to not more than a predetermined divisional number of the feature amount during a predetermined period, it is judged that the vibration measured by the vibration measuring means is the vibration occurring in the vehicle due to the force exerted to turn the fixing means.

17. The method as set forth in claim 14, wherein:
in the step (D),
when each of feature amounts, corresponding to frequency bands of a predetermined frequency or greater, of the feature amounts exceeds a reference value set in advance, it is judged that the vibration measured by the vibration measuring means is the vibration occurring in the vehicle due to the force exerted to turn the fixing means.

18. The method as set forth in claim 14, wherein:
in the step (D),
a certainty degree is found which indicates how certain the vibration measured by the vibration measuring means is the vibration occurring in the vehicle due to the force exerted to turn the fixing means, and
when the found certainty degree is equal to or larger than a predetermined value, it is judged that the vibration measured by the vibration measuring means is the vibration occurring in the vehicle due to the force exerted to turn the fixing means.

19. The method as set forth in claim 14, wherein:
in the step (A), a vibration occurring in a direction in which the vehicle travels is measured.

20. The method as set forth in claim 14, wherein:
in the step (D), the vibration occurring in the vehicle due to the force exerted to turn the fixing means, and the vibration due to said another factor are distinguished from each other in accordance with a plurality of vibrations differently occurring during a predetermined period.

21. The method as set forth in claim 20, wherein:
in the step (D),
a certainty degree is found which indicates how certain the vibration measured by the vibration measuring means is the vibration occurring in the vehicle due to the force exerted to turn the fixing means, and
in cases where the found certainty degree is equal to or larger than a predetermined value and where a predetermined number of certainty degrees equal to or greater than the predetermined value have been obtained during a predetermined period, the recognition processing means judges that the vibration measured by the vibration measuring means is the vibration occurring in the vehicle due to the force exerted to turn the fixing means.

22. The method as set forth in claim 14, further comprising the step of:
(E) judging whether or not a magnitude of a vibration waveform found in accordance with the result of the measurement carried out by the vibration measuring means is equal to or larger than a set value,
wherein:
in the step (E), when the magnitude of the vibration waveform is equal to or larger than the set value, a process is carried out so as to distinguish between (i) the vibration occurring in the vehicle due to the force exerted to turn the fixing means, and (ii) the vibration occurring due to said another factor.

23. A vehicle wheel stealing detecting program for causing a computer, provided in a vehicle wheel stealing detecting apparatus, to execute the process steps as set forth in claims 14 through 22.

24. A computer-readable recording medium for storing the program as set forth in claim 23.
